(19) United States
(12) Patent Application Publication
(10) Pub. No.: US 2003/0159776 A1
(43) Pub. Date: Aug. 28, 2003

(54) Apparatus for and method of lining passageways

(76) Inventor: Neil Deryck Bray Graham, Cockburn Waters (AU)

Correspondence Address: HOGAN & HARTSON LLP, ONE TABOR CENTER, SUITE 1500, 1200 SEVENTEENTH ST, DENVER, CO, 80202, US

(21) Appl. No.: 10/276,485

(22) PCT Filed: May 16, 2001
(86) PCT No.: PCT/AU01/00563

(30) Foreign Application Priority Data
May 16, 2000 (AU) PQ 7543
Aug. 1, 2000 (AU) PQ 9124
Nov. 23, 2000 (AU) PR 1624

(51) Int. Cl. B32B 1/00

(52) U.S. Cl. 156/293; 156/294; 156/287; 156/391

(57) ABSTRACT

A method of, and apparatus for, lining the interior surface (13) of a passageway (15) such as a pipeline, involving progressive installation of a liner (11) on the interior surface (13) of the passageway (15) or on a substrate applied to the interior surface of the passageway by adhesively bonding the liner (11) in position. The liner (11) is bonded to the inner surface (13) of the passageway (15), or onto a substrate applied to the inner surface of the passageway, using a substance which hardens and which together with the liner (11) forms a rigid structure. The apparatus (10) includes a body (23) adapted to be moved along the passageway (15) to progressively install the liner (11). The body (23) also applies the adhesive for the bonding process.

### FIELD OF THE INVENTION

This invention relates to an apparatus for, and a method of, lining ducts and other passageways.

The invention has been devised particularly, although not solely, for internally lining fluid flow passageways such as water and gas pipes, and sewer and drainage pipelines.

The invention may be used to line existing pipelines and other passageways as either a remedial action in cases where the existing pipelines have deteriorated, or to enhance the characteristics of the boundary surface of the pipeline or other passageway to reduce resistance to fluid flow therealong. Additionally, the invention may be used to line existing pipelines and other passageways in order to extend the service life thereof. Similarly, the invention may be used to line new pipelines and other passageways in order to provide longevity in terms of service life.

### BACKGROUND ART

Throughout the world, there are numerous pipelines which have been installed for many years and which have deteriorated to an extent that remedial action is required in order to maintain the effectiveness of the pipeline or to avoid leakage. This is particularly so for municipal infrastructure involving pipe networks such as sewers and water mains.

There have been various proposals for performing remedial work on such pipelines, including installing liner sections on the interior walls of the pipelines and spraying coating materials on the interior walls.

One proposal to line existing pipelines is disclosed in U.S. Pat. No. 4,687,677 (Jonasson). The proposal involves introduction of a flexible hose-shaped liner containing a curable plastic material into the pipeline to be lined. The flexible liner is introduced into the pipeline in an uncured state and is pressed out against the inside of the pipeline by means of compressed air. The flexible liner is then hardened in place by exposing the curable plastic material to radiation energy. A somewhat similar proposal is disclosed in WO 92/16784 (Lundmark). In this latter proposal, the hose-shaped liner is introduced into the pipeline by either drawing in the liner or by everting the liner into the pipeline.

A disadvantage of such proposals involving installation of a liner which contains a curable plastic material and which can be cured upon exposure to radiation energy is that the liner must be manufactured and prepared under fully-controlled conditions at a production facility remote from the installation site and then transported to the installation site. This can contribute significantly to the cost of a pipe lining operation.

It is against this background that the present invention has been developed.

### DISCLOSURE OF THE INVENTION

The present invention provides a method of lining the interior surface of a passageway comprising the steps of: providing a flexible liner for the interior surface of the passageway, and progressively installing the liner on the interior surface of the passageway or on a substrate applied to the interior surface of the passageway by bonding it thereto.

The liner is preferably installed onto the interior surface of the passageway or the substrate by being adhesively bonded thereto.

The liner may be bonded to the inner surface of the passageway, or onto a substrate applied to the inner surface of the passageway, using a substance which hardens and which together with the liner forms a rigid structure. In this way, the liner and the substance together form a composite material which forms the rigid structure. Such a substance may comprise an acrylic resin such as methyl methacrylate. In certain applications it may be desirable to provide the resin as a foam. This may be achieved by aerating the resin, such as by mechanical aeration means or by incorporating an aerating substance in the foam.

The liner may comprise a structural textile fabric such as woven fibreglass fabric. The textile fabric may have a smooth coating on one face thereof to present a smooth surface as the boundary wall of the lined passageway. Alternatively, the liner may comprise a plurality of layers. The layers may be bonded one to another prior to installation of the liner or they may be so bonded as part of the liner installation process.

In one arrangement, the liner may be assembled within the passageway from at least two longitudinal sections of flexible material having the longitudinal edges thereof adapted to be joined one to another to form the liner. Accordingly, the method may further comprise delivering said at least two longitudinal sections of flexible material into the passageway and assembling said at least two longitudinal sections of flexible material to form the liner.

In another arrangement, the liner may be delivered to the passageway in the form of a flexible tube structure. Where the liner comprises a plurality of layers, the layers may be positioned one about another to form the tube structure.

Where the liner is installed by an adhesive bonding process, the method may further comprise the step of applying an adhesive substance to the interior surface of the passageway or any substrate thereon and pressing the liner into position for adhesive bonding thereto.

The method may further comprise the step of delivering an inflation fluid into the region of the passageway in which the flexible liner has been installed to press the liner into intimate contact with the internal surface or any substrate applied thereto. Typically, the inflation fluid comprises air but it may be in the form of any other suitable fluid, either liquid or gas or indeed a combination of liquid and gas.

The substrate may comprise a lining material such as concrete applied to the internal surface of the passageway prior to installation of the liner.

The method may further comprise the step of applying the substrate to the internal surface of the passageway prior to installation of the liner.

The liner may have a circumferential size marginally larger than the circumferential size of the surface onto which it is to be applied. In such circumstances, the method may further comprise forming one or more longitudinally extending tucks in the liner in order to reduce the circumferential size thereof to provide a snug fit with the surface to which it is to be applied.

Where the liner is assembled from at least two longitudinal sections of flexible material having longitudinal edges thereof adapted to be joined one to another, such an arrangement may be similar to that disclosed in International Application PCT/AU95/00667 in the name of Neil Deryck Bray Graham and the present Applicant's International Patent Application PCT/AU01/00386, the contents of both of which are incorporated herein by way of, reference. The longitudinal edges may be joined in overlapping relationship.

The present invention also provides a method of installing a rigid liner on the interior surface of a passageway comprising the steps of: providing a flexible liner comprising a structural textile fabric such as woven fibreglass fabric, applying an adhesive resin to the flexible liner, and progressively installing the flexible liner on the inner surface of the passageway or on a substrate applied to the interior surface of the passageway, whereby the textile fabric and the resin provide a composite material which forms the rigid liner upon curing of the resin.

The adhesive resin may be applied onto the flexible liner or onto the surface to which the liner is to be bonded or both onto the liner and onto said surface.

The present invention also provides apparatus for lining the internal surface of a passageway comprising a body adapted to be progressively moved along the passageway for installing a flexible liner onto the interior surface of the passageway or any substrate applied thereto, the body having means to progressively install the liner onto the inner face or any substrate positioned thereon as it moves through the passageway.

The body may incorporate a guide structure about which the liner can turn to provide an inner liner portion and an outer liner portion turned back with respect to the inner liner portion.

Preferably, the guide surface is configured to facilitate spreading of the outer liner portion in a manner which precludes the formation of irregularities such as wrinkles, creases and folds.

The guide surface may extend between first and second boundaries with at least one of the boundaries being arcuate, characterised in that the two boundaries are of substantially equal length.

The equality of length of the two boundaries may be achieved by one of the boundaries being of sinusoidal profile and the guide surface having a further sinusoidal profile between the two boundaries, the two sinusoidal profiles being out of phase such that the troughs on each profile are aligned with the crests on the other profile in the direction of movement of the longitudinal sections of flexible material over the guide surface.

The guide surface may be defined by a guide ring having an outer circumference defining one of the boundaries and an inner circumference defining the other of the boundaries. In such an arrangement, the inner circumference is the boundary which is of sinusoidal profile. Additionally, the further sinusoidal profile is provided at one axial end of the ring.

Preferably, the body has provision for delivering an adhesive substance for adhesively bonding the liner onto the internal surface of the passageway or onto any substrate applied thereto.

Where the flexible liner is assembled from at least two longitudinal sections of flexible material having longitudinal edges thereof adapted to be joined one to another, the body may have provision for such assembly. The various longitudinal sections of flexible material which are assembled to form the liner may be joined together at adjacent longitudinal edges with a connector means comprising a first connector element in the form of a male element and a second connector element in the form of a female element. The arrangement is such that the male connector element of each longitudinal section of flexible material is arranged for engagement with the female connector element of a neighbouring longitudinal section of flexible material in the manner of a zipper. In this way, the longitudinal edges of the longitudinal sections of flexible material are progressively brought towards each other and subsequently zipped together. A suitable connector means is as disclosed in the aforementioned patent applications, the contents of which are in relation to the connector means are also incorporated herein by way of reference.

In another arrangement, the connector means may be adapted to join adjacent longitudinal edges of the longitudinal sections of flexible material in overlapping relationship.

Where the liner is assembled from longitudinal sections of flexible material, such longitudinal sections may be progressively delivered to the body along a delivery path from a station where a supply of such material is stored, typically in roll form. The longitudinal sections of flexible material may progressively unroll from the storage roll as the body moves along the passageway.

Where the liner comprises a tube structure, the latter may be progressively delivered to the body in a collapsed condition along a delivery path from a station where the tube structure is stored, typically in roll form. The tube structure may progressively unroll from the storage roll as the body moves along the passageway.

The body may incorporate means for applying pressure to the liner during installation thereof on the internal surface of the passageway or any substrate thereon. Such means may comprise a pressure surface for engaging the liner to urge the latter into position. The pressure surface may be defined by a flexible wall the interior face of which is subjected to fluid pressure for pressing the flexible wall into contact with the liner.

### BRIEF DESCRIPTION OF THE DRAWINGS

The invention will be better understood by reference to the following description of several specific embodiments thereof as shown in the accompanying drawings in which:

FIG. 1 is a schematic view of apparatus according to a first embodiment installing a liner on the interior surface of a pipeline;

FIG. 2 is a schematic cross-sectional view of the pipeline with the liner installed therein;

FIG. 3 is a fragmentary view of the side wall of the pipeline illustrating the liner position;

FIG. 4 is a schematic view of an installation head forming part of the apparatus according to the embodiment;

FIG. 5 is a fragmentary view of part of the installation head illustrating the arrangement for assembling longitudinal sections of flexible material to form the liner;

FIG. 6 is a schematic end view of part of the installation head;

FIG. 7 is a side view of that part of the installation head illustrated in FIG. 6;

FIG. 8 is a schematic view of a carriage structure for supporting umbilicals leading to the installation head;

FIG. 9 is an end view of the carriage structure of FIG. 8;

FIG. 10 is a schematic side view of an installation head of apparatus according to a second embodiment;

FIG. 11 is a schematic view of the installation head of FIG. 10 showing some internal workings thereof;

FIG. 12 is a schematic view of an installation head of apparatus according to a third embodiment;

FIG. 13 is a schematic cross-sectional view of a pipeline with a liner installed therein, the liner incorporating a tuck accommodating a conduit;

FIG. 14 is a fragmentary view of the arrangement shown in FIG. 13;

FIG. 15 is a fragmentary schematic view of apparatus according to a fourth embodiment installing a liner on the internal surface of a pipeline, showing in particular the manner of delivery of the liner into the pipeline;

FIG. 16 is a fragmentary view illustrating a fluid seal mechanism used with a pressure chamber in the embodiment of FIG. 15;

FIG. 17 is a schematic view of apparatus according to a fifth embodiment installing a liner on the internal surface of a pipeline;

FIGS. 18 to 21 illustrate various steps in a procedure for connecting a lateral to a pipeline which has been lined using apparatus according to the invention;

FIG. 22 is a fragmentary view of part of the installation head of apparatus according to a sixth embodiment, illustrating the arrangement for assembling longitudinal sections of flexible material to form the liner;

FIG. 23 is a schematic end view of the installation head of apparatus according to a seventh embodiment;

FIG. 24 is a side view of the installation head of FIG. 23;

FIG. 25 is a perspective view of a guide ring structure employed in the apparatus according to the seventh embodiment;

FIG. 26 is a further perspective view of the guide ring structure;

FIG. 27 is a front elevational view of the guide ring structure;

FIG. 28 is a side elevational view of the guide ring structure;

FIG. 29 is a schematic view illustrating some geometrical characteristics of the ring structure;

FIG. 30 is a schematic view of a further form of connector means for joining adjacent edges of longitudinal sections of flexible material together to form an assembled liner;

FIG. 31 is a schematic view of a still further form of connector means;

FIG. 32 is a detail view of the connector means shown in FIG. 31;

FIG. 33 is a view illustrating two liners positioned one about the other to define a gap therebetween to receive a suitable substance such as concrete for forming a pipe;

FIG. 34 is a schematic view of an installation head forming part of pipelining apparatus according to a further embodiment;

FIG. 35 is a detailed view of part of the apparatus shown in FIG. 34;

FIG. 36 is a schematic cross-sectional view of a pipeline with one form of pipelining system installed therein;

FIG. 37 is a cross-sectional view of another pipeline with a further form of pipelining system installed therein;

FIG. 38 is a cross-sectional view of a pipeline with still another form of pipelining system installed therein; and

FIG. 39 is a cross-sectional view of a pipeline showing a pipelining apparatus located therein installing a still further pipelining system within the pipeline;

FIG. 40 is a schematic view of part of an apparatus according to a further embodiment for lining the interior surface of a pipeline;

FIG. 41 is a view similar to FIG. 40 with the exception that the pipeline is not shown;

FIG. 42 is a schematic fragmentary view illustrating the liner in position on the interior surface of a pipeline, the liner being in two layers;

FIG. 43 is a schematic view illustrating the liner in an inflated condition in the pipeline;

FIG. 44 is a schematic view illustrating the path followed by the liner during the installation process;

FIG. 45 is an end view of a guide ring structure forming part of the apparatus of this embodiment;

FIG. 46 is an end view of a retaining structure operating in association with the guide ring structure;

FIG. 47 is a view similar to FIG. 46 with the exception that the retaining structure is also shown with a spreader;

FIG. 48 is a side view illustrating the guide ring structure and the retaining structure in interlocking engagement;

FIG. 49 is a side view of a guide ring structure and a corresponding retaining structure in the installation head of apparatus according to a still further embodiment; and

FIG. 50 is a cross-sectional view of FIG. 49 illustrating co-operation between the guide ring structure and the retaining structure.

### BEST MODE(s) FOR CARRYING OUT THE INVENTION

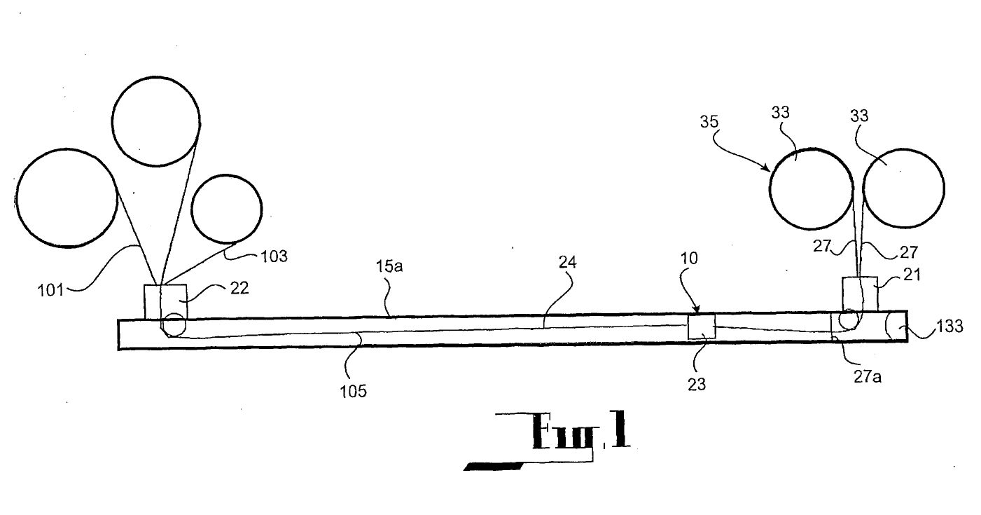

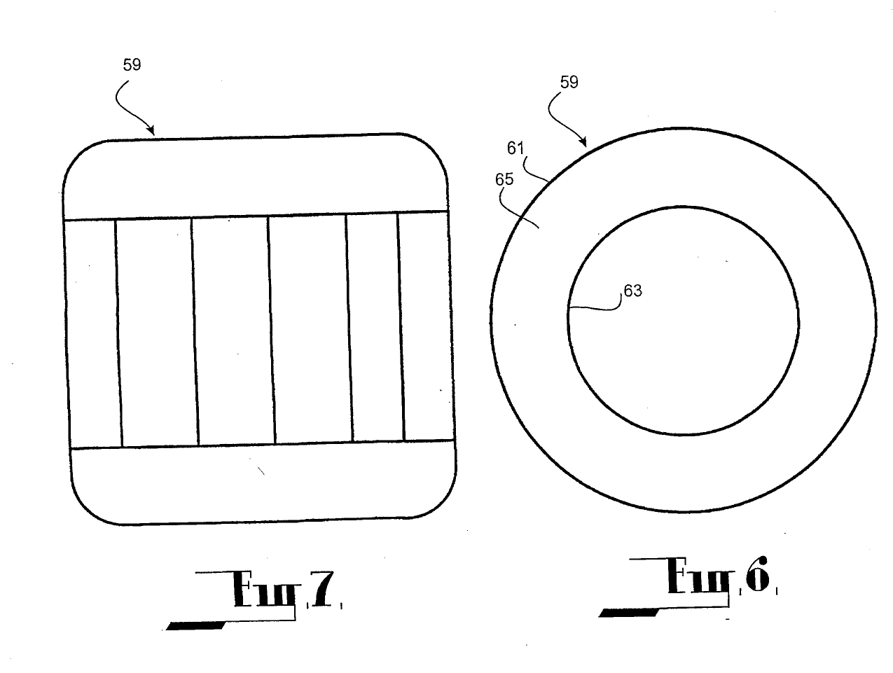

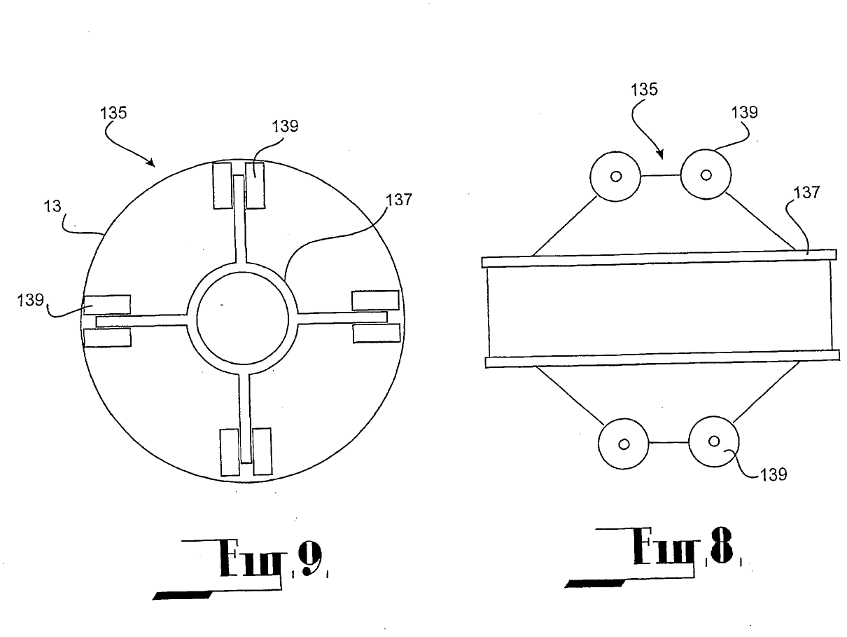

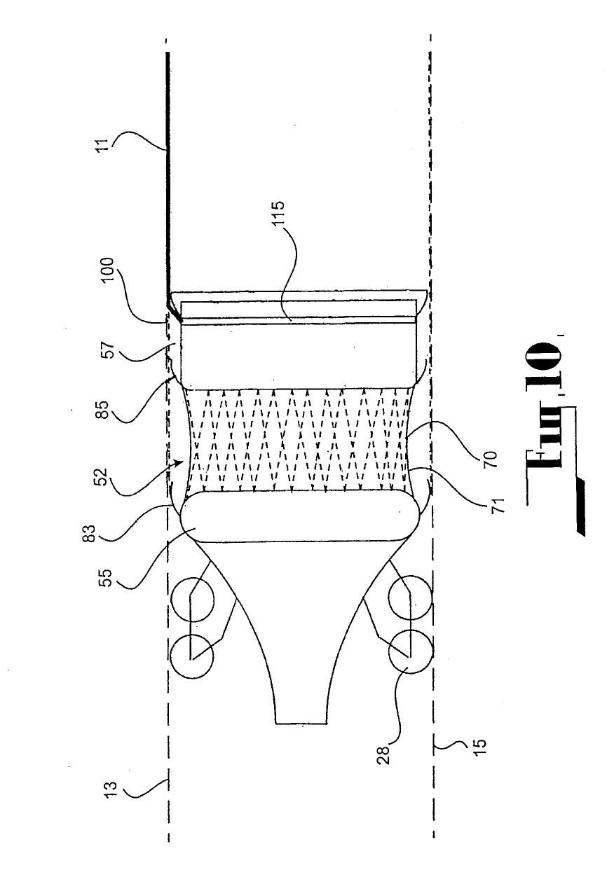

Referring now to FIGS. 1 to 9 of the accompanying drawings, there is shown apparatus 10 or installing a liner 11 onto the interior surface 13 of a pipeline 15. The liner 11 provides a hermetically sealed barrier that is resistant to both corrosion and wear.

In this embodiment, the liner 11 is applied to a substrate 17 in the form of an intermediate lining 19 of cement applied to the interior surface 13 of the pipeline 15. The substrate 17 is applied to the interior surface 13 of the pipeline in cases where the internal surface has been significantly degraded and requires refurbishment prior to installation of the liner 11.

As seen in FIG. 1 of the drawings, access to the interior of the pipeline 13 is gained through a first access port 21 and a second access port 22, the two access ports being spaced apart along the pipeline, with the section 15a of pipeline 15 being lined being disposed between the two access ports 21, 22.

The apparatus 10 comprises a body 23 which is mounted on rollers 28 and which includes an installation head 25. The body 23 is adapted to be progressively moved along the section 15a of the pipeline 15 to progressively install the liner 11.

In this embodiment, the body 23 is adapted to be pulled through the pipeline by a tow line 24 extending from the body 23 to a station 26 located exteriorly of the pipeline adjacent the second access port 22.

The liner 11 comprises a plurality of longitudinal sections 27 of flexible material, there being four such sections in this embodiment. The flexible material is a cloth comprising fibreglass fabric with a lining on one face thereof, the lining being to the interior of the pipeline exposed when the liner is installed. The lining is selected according to the demands placed on the liner 11 within the pipeline 15. For example, where abrasion and wear resistance is required, the lining may be formed of polypropylene. In other cases, the lining may be formed of polyester (Mylar), nylon urethane rubber or other suitable material!

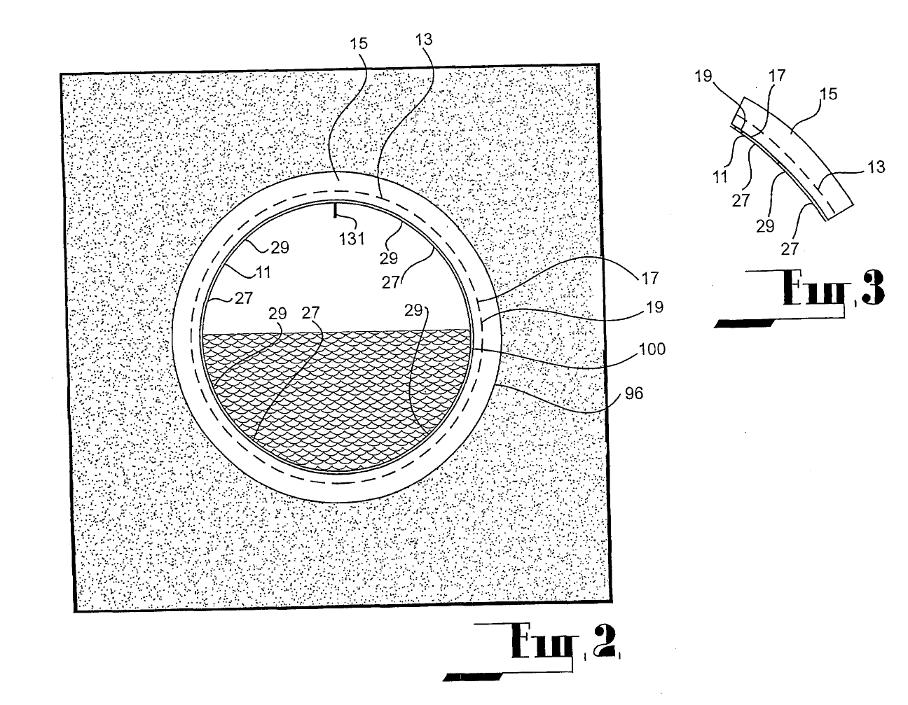

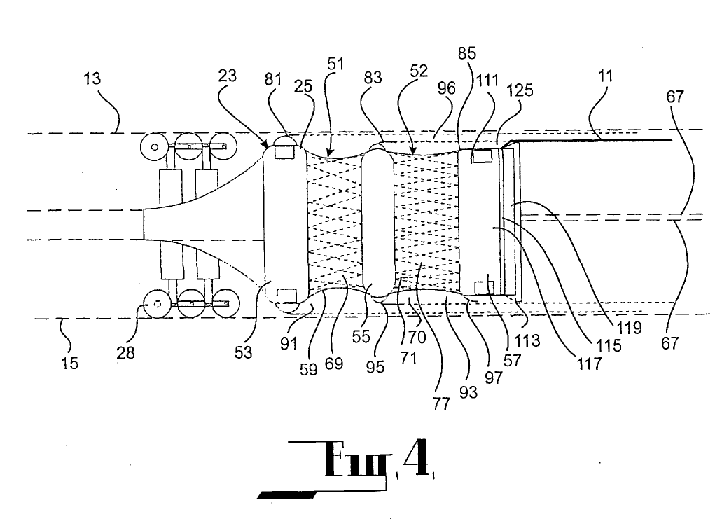

The liner 11 is assembled from the four longitudinal sections 27, with the longitudinal edges of the longitudinal sections being adapted to be joined one to another to form the liner by connector means 29. Each connector means 29 comprises a first connector element in the form of a male connector and a second connector element in the form of a female element. The arrangement is such that the male element of each longitudinal section 27 is arranged for engagement with the female element of the neighbouring longitudinal section in the manner of a zipper. The male and female elements are guided into zipping engagement in a manner to be described. In this way, the longitudinal sections 27 can be zipped together to form the liner 11, as best seen in FIGS. 2 and 3 of the drawings.

The connector means 29 provides a continuous and fluid-tight connection between the various longitudinal sections 27.

The longitudinal sections 27 of flexible material are stored in roll form in rolls 33 at a station 35 located exteriorly of the pipeline 15 adjacent the first access port 31. One end 27a of each longitudinal section 27 sealingly attached to the interior surface 13 of the pipeline 15 at the location where the lining operation is to commence, which in this case is adjacent the first access port 21. As the body 23 advances along the pipeline 15 away from the location at which the end 27a is bonded to the pipeline, lengths of the various longitudinal sections 27 are drawn into the pipeline and assembled to form the liner 11. The various longitudinal sections 27 are assembled in a fashion similar to the arrangement disclosed in the aforementioned patent applications (where longitudinal sections of flexible material are assembled to form a shroud).

The longitudinal sections 27 extend from the rolls 33 through the first access port 31 and along that part of the pipeline section 15a which has been lined to the body 23. The body 23 incorporates a guide structure 41 comprising guide rollers 44 over which the longitudinal sections 27 can pass. At the body 23, the liner 11 turns around the guide structure 41 to provide an inner liner portion 43 and an outer liner portion 45. The outer liner portion 45 is turned back with respect to the inner liner portion 43 and moves outwardly towards the interior surface 13 of the pipeline 15. Prior to contacting the guide structure 41, the longitudinal sections 27 are zipped together to form the liner 11. The respective male and female elements of the longitudinal sections 27 are guided into gripping engagement with each other by way of a slider 47. Guide means (not shown) such as further guide rollers are provided to guide the respective male and female elements to the slider 47.

The male and female elements of the longitudinal sections 27 may be of any suitable form, such as for example a connector assembly as disclosed in International Patent Application PCT/AU01/00386, the contents of which are incorporated herein by way of reference.

The installation head 25 in this embodiment incorporates a first applicator means 51 for applying a layer of concrete to the interior surface 13 of the pipeline 15 to provide the substrate 17.

The installation head 25 also incorporates a second applicator means 52 for applying an adhesive substance such as resin to the inner face of the substrate 17 for bonding the liner 11 thereto.

The installation head 25 includes a leading spreader member 53, an intermediate spreader member 55, and a trailing spreader member 57.

The leading and intermediate spreader members 53, 55 are connected together by a leading bladder structure 59 which comprises an outer annular membrane 61 and an inner annular membrane 63. The two membranes 61, 63 are circumferentially spaced with respect to each other to define an annular chamber 65 therebetween. Cross linked cables 69 (as shown in FIG. 4) are associated with the bladder structure 59 to allow the installation head 25 to articulate for passing around bends and corners in the pipeline while maintaining the integrity of the structure.

Similarly, a trailing bladder structure 70 extends between the intermediate spreader member 55 and the trailing spreader member 57. The trailing bladder structure 70 comprises an outer annular member 71 and an inner annular member (not shown) in spaced apart relationship to define an annular chamber therebetween. Cross-linked cables 77 extend between the intermediate spreader ring 55 and the trailing spreader member 57.

The first applicator means 51 comprises the combination of the leading spreader member 53, the intermediate spreader member 55 and the leading bladder structure 59 extending therebetween.

Similarly, the second applicator means 52 comprises in combination the intermediate spreader member 55, the trailing spreader member 57 and the trailing flexible bladder structure 70 extending therebetween.

The leading spreader member 53 carries a leading wiper seal 81, the intermediate spreader member 55 carries an intermediate wiper seal 83 and the trailing spreader member 57 carries a trailing wiper seal 85, as best illustrated in FIG. 4 of the drawings.

A holding chamber 91 is defined around the leading bladder structure 59 between the leading and intermediate wiper seals 81, 83.

Similarly, a trailing holding chamber 93 is defined around the trailing bladder structure 70 between the intermediate and trailing wiper seals 83, 85.

The leading holding chamber 91 is adapted to receive a supply of cement for applying the intermediate lining of cement 19 to the interior surface 13 of the pipeline 15 to form the substrate 17 as the body 23 advances along the pipeline.

The leading wiper seal 81 is of flexible construction and is adapted to wipe against the interior surface 13 of the pipeline 15 as the body 23 moves therealong. In FIG. 4 of the drawings, the leading wiper seal 81 is illustrated in a condition spaced from the interior surface 13 of the pipeline for illustrative purposes but, in reality, the seal does contact the interior surface 13.

The outward extent of the intermediate wiper seal 83 is less than that of the leading wiper seal 81 so as to be spaced from the interior surface 13 of the pipeline such that a gap 95 is defined therebetween. With this arrangement, wet concrete contained within the leading holding chamber 91 is applied to the internal surface 17 of the pipeline as a layer 96, with the inner face of the cement layer 96 being formed by the intermediate wiper seal 83. The layer 96 is of a thickness corresponding to the gap 95 and provides the intermediate lining 19.

The outward extent of the trailing wiper seal 85 is less than that of the intermediate wiper seal 83 such that it is spaced from the inner face of the concrete layer 96 applied to the interior surface 13 of the pipeline. In this way, the trailing wiper seal 85 in combination with the inner face of the layer 19 of concrete provides a gap 97 through which a layer 100 of adhesive contained within the trailing holding chamber 93 is applied to the inner face of the concrete layer 96.

Cement is delivered to the leading holding chamber 91 by way of a cement delivery line 101. Similarly, adhesive such as resin is delivered to the trailing holding chamber 93 by way of a adhesive delivery line 103.

Venting systems (not shown) are associated with the holding chambers 91, 93 to allow air to vent therefrom.

The concrete delivery line 101 and the adhesive delivery line 103 are incorporated in the umbilical structure 105 which extends to the body 23 from the second access port 22. The tow line 24 is also incorporated in the umbilical structure 105, as is any other necessary service lines such as electrical supply lines and air lines. The various lines are wound onto storage rolls 109 as the body 23 moves along the pipeline.

The leading bladder structure 59 incorporates means for vibrating the outer annular membrane 61 so as to vibrate concrete delivered into the leading holding chamber 31 to assist intimate deposition of the concrete onto the interior surface 13 of the pipeline. The outer annular membrane 61 may be vibrated by any suitable means, such as by provision of a vibrating mechanism within the leading bladder structure 59. Alternatively, the cross-linked cables 69 may be subjected to an influence (such as a magnetic or electric field) to stimulate vibration therein.

Similarly, the trailing bladder structure 70 may incorporate means to induce vibration in the outer annular membrane 71 thereof to assist intimate deposition of the adhesive onto the inner face of the concrete layers 96. A similar vibration mechanism to that used in relation to the leading bladder structure 59 may be utilised to induce vibration in the outer annular membrane 71.

The trailing spreader member 57 is incorporated in a trailing section 111 of the installation head 25. The trailing section 111 further includes a mandrel 113 which urges the assembled liner 11 into intimate contact with the adhesive layer 100 applied to the concrete layer 96. The assembled liner 11 is delivered to the mandrel 113 through a delivery slot 115 formed in the trailing section 111. The delivery slot 115 separates the trailing section 111 into a front part 117 and a rear part 119, the front and rear parts being linked together by a structure 118 including gussets 120 which does not interfere with delivery of the assembled liner 11 through the delivery slot 115.

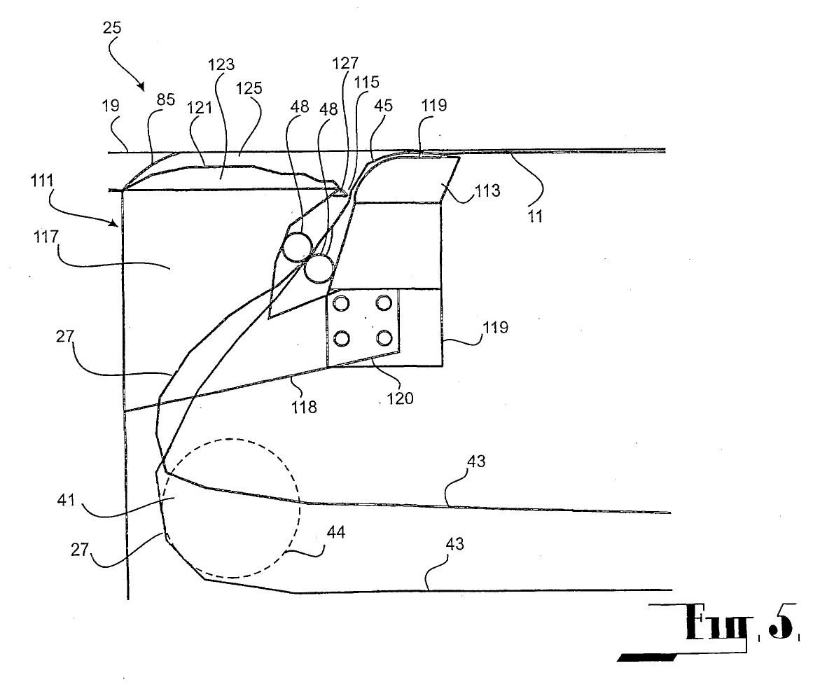

The mandrel 113 is located immediately behind the delivery slot 115, as best seen in FIG. 5 of the drawings so as to urge the flexible liner 11 into intimate contact with the inner face of the concrete layer 96 by way of the adhesive. The mandrel 113 presents a contact face 119 to the assembled liner 11 delivered through the delivery slot 115, the contact face 19 being adapted to vibrate to press the liner into bonding contact with the adhesive layer 99.

The front part 117 may incorporate a vibrating diaphragm 121 defined by an inflatable cuff structure 123 disposed rearwardly of the trailing wiper seal 85. The vibrating diaphragm 121 assists the application of adhesive to the inner face of the concrete layer 19. A zone 125 is defined around the diaphragm 121 between the trailing wiper seal 85 and the liner 11 delivered through the delivery slot 115. Adhesive contained within zone 125 is also applied to the face of the liner 11 which contacts the outer face of the cement layer 96. A seal mechanism 127 is associated with the delivery slot 115 to prevent ingress of adhesive substance contained within the zone 125 into the internal workings of the trailing part 111 of the delivery head.

The assembled liner 11 may be of a cross-sectional circumferential size larger than the size defined by the inner surface of the concrete layer 96. In such circumstances, pinch rollers (not shown) may be provided to form a tuck 131 in the assembled liner to construct it to a size for a snug fit against the concrete layer.

An inflation fluid is delivered into the lined section of the pipeline 15 behind the advancing body 23 to maintain the liner 11 in intimate contact with the inner face of the concrete layer 96 while the adhesive sets. The inflation fluid may be of any suitable form but typically is either air or water. To contain the inflation fluid, it is necessary to block the pipeline 15, this being illustrated in FIG. 1 of the drawings by provision of a removable plug 133 in the pipeline. Where the inflation fluid is a gas such as air, a seal (not shown) would also be required at the first access port in order to maintain the pressurised environment in the pipeline. Typically, the inflation pressure is in the order of 2.5 to 5 kpa.

A plurality of carriage structures 135 are provided at spaced intervals along the umbilical structure 105 to provide support therefore. Each carriage structure 135 includes a collar 137 which receives and supports the umbilical structure 105 and rollers 139 for engaging the interior surface of the pipeline.

The carriage structures 139 are demountable for removal through the second access port 22.

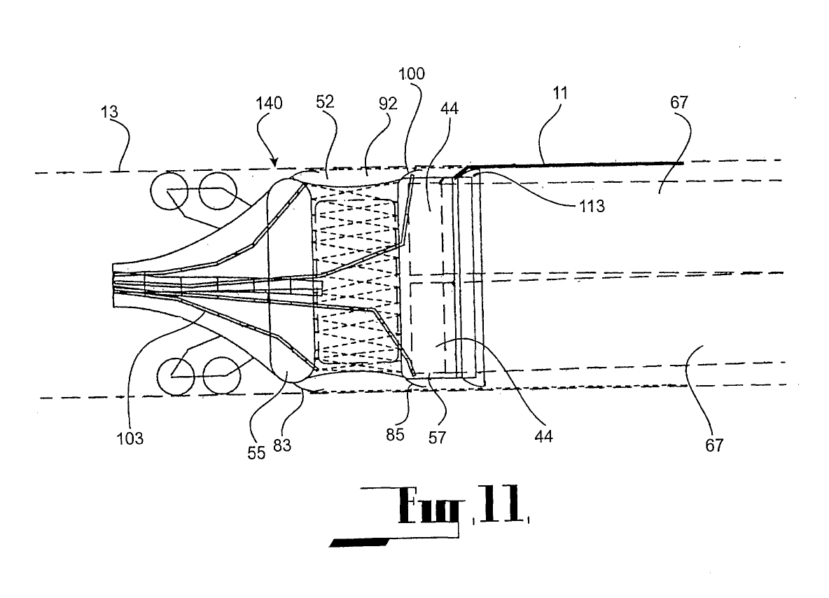

In the first embodiment, the apparatus 10 applied the concrete layer 96 as well as the liner 11. There may, however, be situations where the pipeline has not deteriorated to an extent requiring installation of a concrete layer. In such a case, the liner 11 can be bonded directly on to the interior surface 13 of the pipeline 15. Apparatus 140 for applying the liner 11 directly onto the interior surface 13 is according to a second embodiment as shown in FIGS. 10 and 11 of the accompanying drawings. The apparatus 140 is similar to the first embodiment except that there is no requirement for a first applicator to apply concrete.

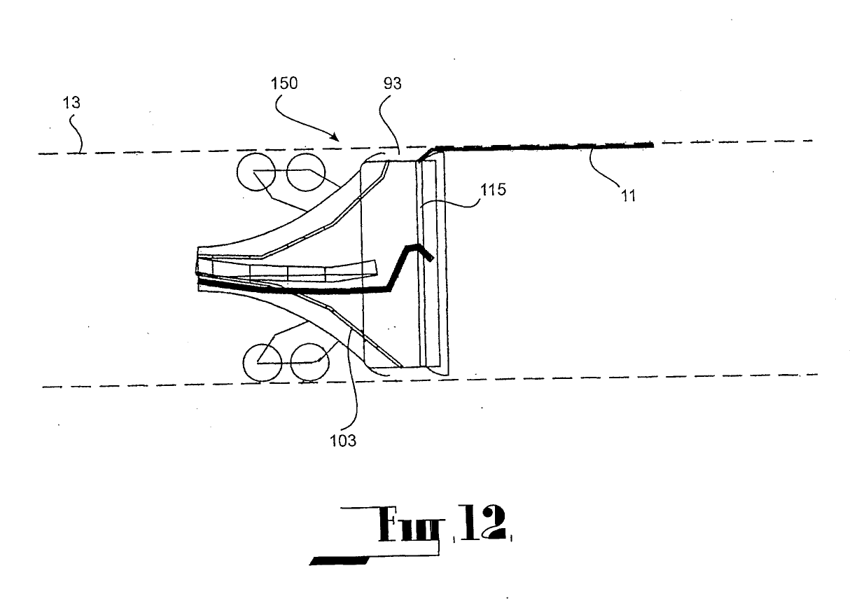

Apparatus 150 according to a third embodiment is illustrated in FIG. 12 of the drawings. In this embodiment, the adhesive holding chamber 93 is immediately adjacent the delivery slot 115 through which the assembled liner 11 passes. Such an arrangement may be particularly suitable in small diameter pipelines where space is limited.

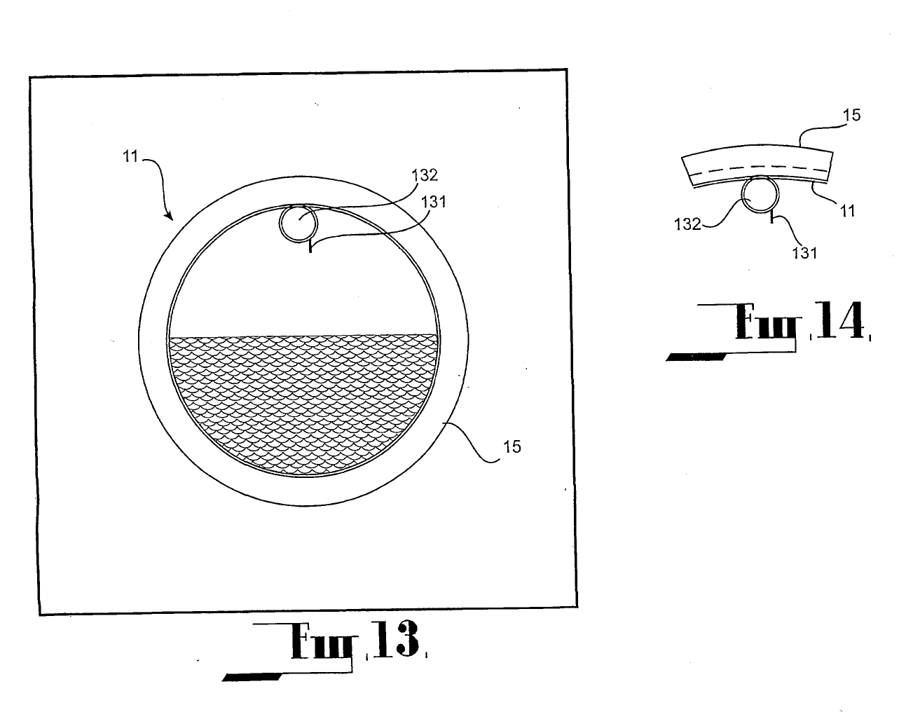

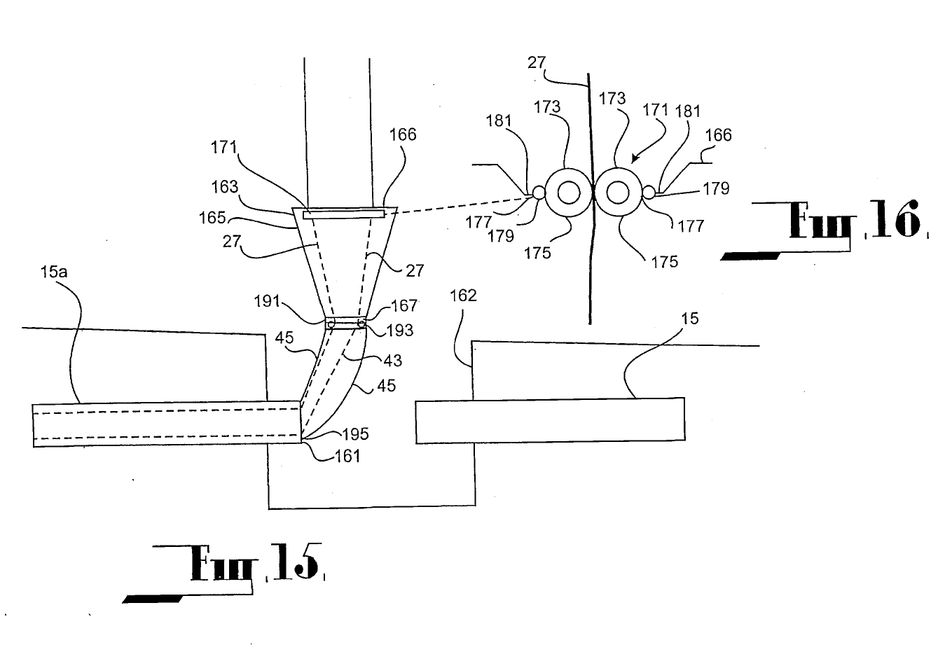

Referring now to FIGS. 13 and 14 of the drawings, there is shown an assembled liner 11 in which a conduit 132 is provided in the tuck 131. This arrangement is advantageous as the conduit 132 can provide a path along the pipeline separate 15 from the main flow path within the liner 11. The path within the conduit 132 may be used for various purposes such as fluid flow or to carry one or more service lines such as telecommunication cabling.

With the embodiments described previously, it was necessary to block the pipeline 15, such as by installation of a removable plug 133 therein, to allow the inflation fluid to be contained within the lined section of the pipeline. The embodiment shown in FIGS. 14 and 15 does not require use of such a plug.

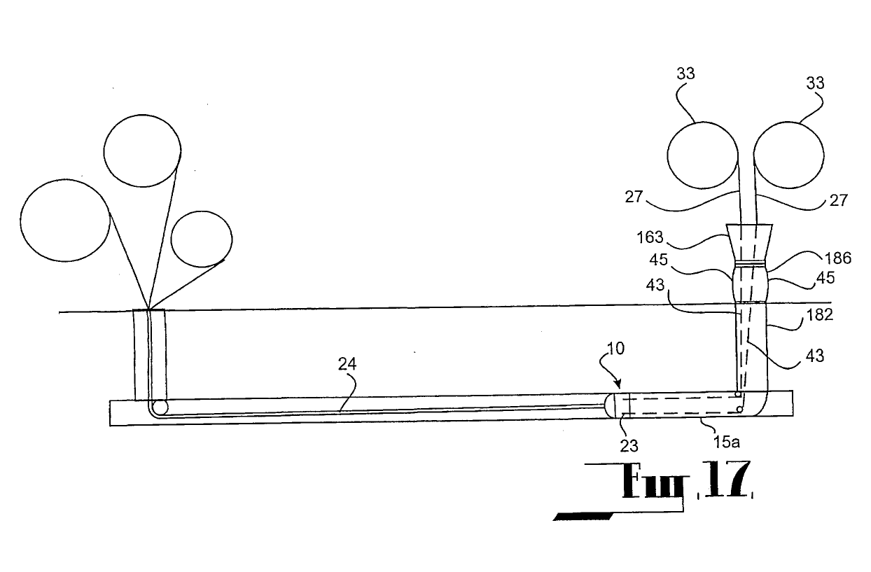

Referring now to FIGS. 15 and 16, there is shown an embodiment in which the apparatus 10 is similar to that described in the earlier embodiments but the manner of delivery of the longitudinal sections 27 of flexible material into the pipeline 15 is different. In this embodiment, the longitudinal sections 27 of flexible material enter section 15a of the pipeline 15 to be lined at entry end 161. The entry end 161 in this embodiment is established by cutting into the pipeline 15 and removing a section thereof to create the entry point. Access for cutting into the pipeline 15 is created by digging an access pit 162 in the ground. It may, however, also be possible to gain access to the section 15a to be lined via a manhole or some other form of entry location.

The longitudinal sections 27 of flexible material enter the pipeline section 15a via a pressure chamber 163. The pressure chamber 163 is defined by a housing 165 having an entry end 166 and an outlet end 167. The pressure chamber 163 receives an inflation fluid, which is typically air, under pressure for the purpose of inflating the assembled liner 11 to maintain it in position while adhesive for bonding it sets

The entry end 166 of the pressure chamber 163 is closed to maintain inflation pressure in the chamber, there being provided a fluid seal mechanism 171 in the entry end to allow entry of each longitudinal section 27. Each fluid seal mechanism 171 comprises a pair of sealing rollers 173 positioned in side-by-side relationship to receive the respective longitudinal section 27 therebetween in sealing engagement as best seen in FIG. 16. Each sealing roller 173 presents a resiliently flexible sealing face 175 which can resiliently deform to conform to the profile of the longitudinal section 27, and in particular to accommodate irregularities such as the male and female elements of the connector means 29 attached to the longitudinal section, as well as any wrinkles which might be present in the textile fabric forming the longitudinal section. Each sealing roller 173 has a rolling seal 177 located in sealing contact with it, the rolling seal 177 having a sealing face 179 formed of a rigid material such as steel. Each rolling seal 177 is in sealing contact with a lip seal 181 attached to a wall 183 at the entry end 166 of the pressure chamber. One or both of the sealing rollers 173 may be driven, if desired.

With this arrangement, the sealing rollers 173, the rolling seals 177 and the lip seals 181 cooperate to maintain a sealed condition at the entry end 166 of the pressure chamber 163 while allowing the longitudinal sections 27 of flexible material to enter the pressure chamber. The rigid nature of the sealing face 179 of each rolling seal 177 allows the establishment of an effective seal with the resiliently flexible sealing face 175 of the sealing roller 173 with which it is in contact, as well as an effective seal with the lip seal 181 with which it is in contact.

The outlet end 167 of the pressure chamber 163 has a collar 191 to which the end 27a of each longitudinal section 27 is sealingly attached. The outer portion 45 of the liner 11 is assembled from the outlet end 167 of the pressure chamber 163 to the body 23 of the apparatus 10 in the pipeline section 15a and so provides a path for inflation fluid to enter the lined section of the pipeline 15 behind the advancing body 23 to maintain the liner 11 in intimate contact with the interior surface 13 of the pipeline 15, or the inner surface of any concrete layer applied thereto, while the adhesive sets. A particular advantage of this arrangement is that it avoids the need to insert a plug into the pipeline section 15a to contain the inflation fluid, as was required with earlier embodiments described.

The housing 165 of the pressure chamber 163 tapers inwardly from the entry end 166 to the outlet end 167. In moving from the entry end 166 to the outlet end 167, the longitudinal sections 27 (which constitute the inner portion 43) are necked down by guide rollers 193 to a size which can enter the entry end 161 of the pipeline section 15a. Guide rollers 195 are also provided at the entry end 161 of the pipeline section 15a to guide the longitudinal sections 27 as they approach and enter the entry end 161 of the pipeline section 15a.

Even though the outer portion 45 of the liner 11 is assembled from the outlet end 167 of the pressure chamber 163, the body 23 only operates from the entry end 161 of the pipeline section 15a. It is from that point that the outer portion 45 assembled liner 11 is bonded in position.

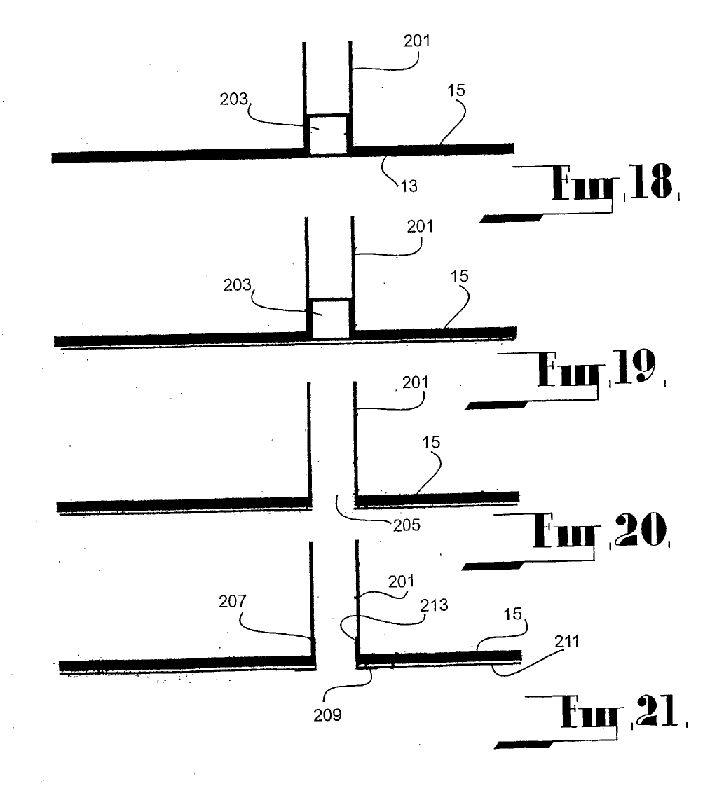

FIG. 17 illustrates an embodiment which is somewhat similar to the previous embodiment, except that access to the pipeline section 15a is via access pit 182. It will be noted that the outer portion 45 is illustrated in a somewhat bulging condition at 186, owing to the inflation pressure.

The various embodiments described above relate to installation of a liner in a pipeline section without regard to any branch lines, or laterals, extending from the pipeline section. Where there is a lateral in a pipeline, a special procedure is required to ensure that the lateral is not permanently sealed off from the pipeline by the lining operation. Such a procedure will now be described with reference to FIGS. 18 to 21 of the accompanying drawings.

Referring to FIGS. 18 to 21, there is shown a lateral 201 extending from pipeline 15. The following procedures which are necessary because of the presence of the lateral, including identification of the existence, and location, of the lateral, may be performed using a remotely operated vehicle (such as a “pipe rat”) designed to travel along the pipeline and carry out various operations under the remote control of an operator.

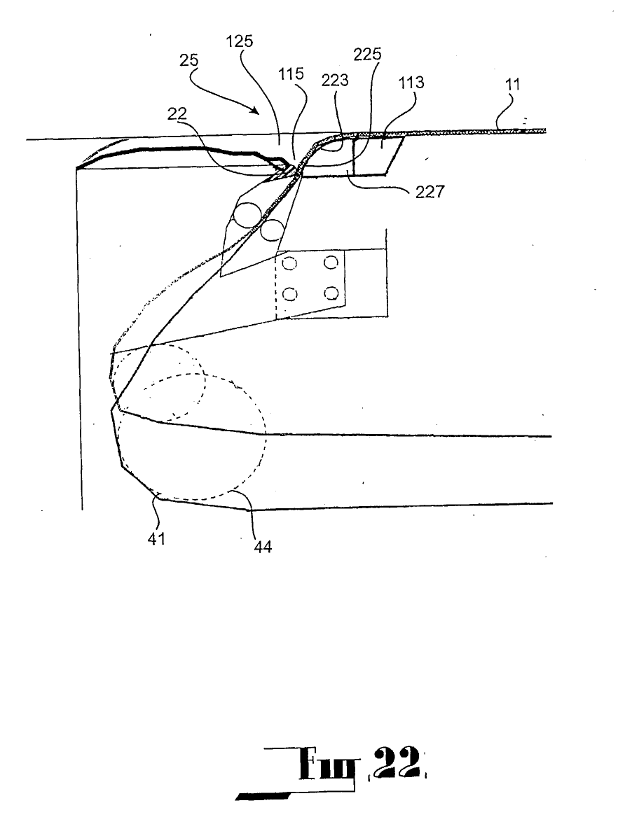

Once the existence, and location, of the lateral 201 has been identified, a bung 203 is inserted into the lateral adjacent the location at which it opens onto the pipeline, as illustrated in FIG. 18 The insertion of the bung 203 is performed by the remotely operated vehicle. The presence of the bung 203 seals the lateral 201 against the entry of concrete and adhesive applied to the interior surface 13 of the pipelines 15 by the apparatus 10 during the lining operation, as illustrated in FIG. 19.

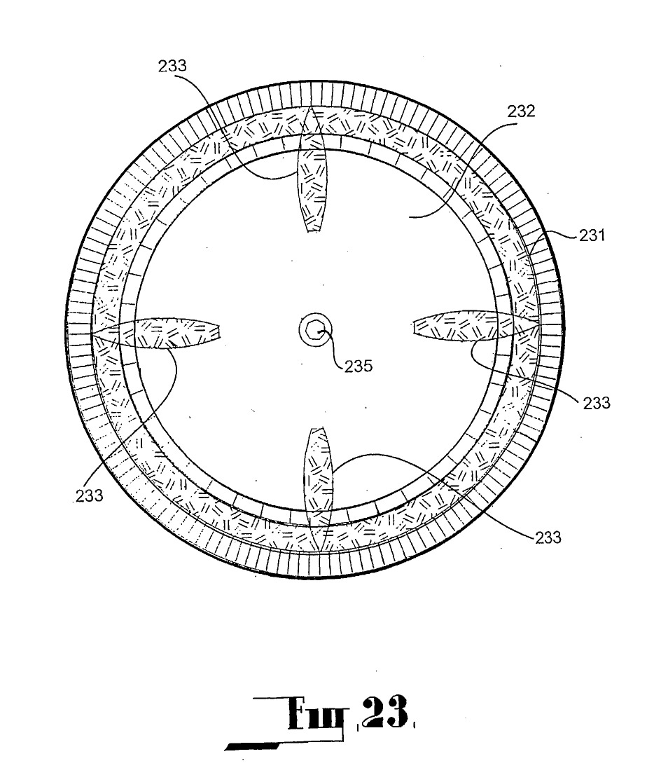

The bung 203 incorporates a device, such as a radio antenna in the form of a copper ring, which enables the location of the bung to be identified after the lining operation. At the stage where the lateral 201 is to be reconnected to the pipeline 15, the location of the lateral 201 with respect the pipeline 15 is identified by sensing the location of the bung 203. Hole 205 is then cut into the lined wall of the pipeline 15 from the interior of the pipeline 15 using a cutting device carried by the remotely operated vehicle. The bung 203 is then removed to exposed the lateral 201, as illustrated in FIG. 20. The area around the hole 205 is then cleaned.

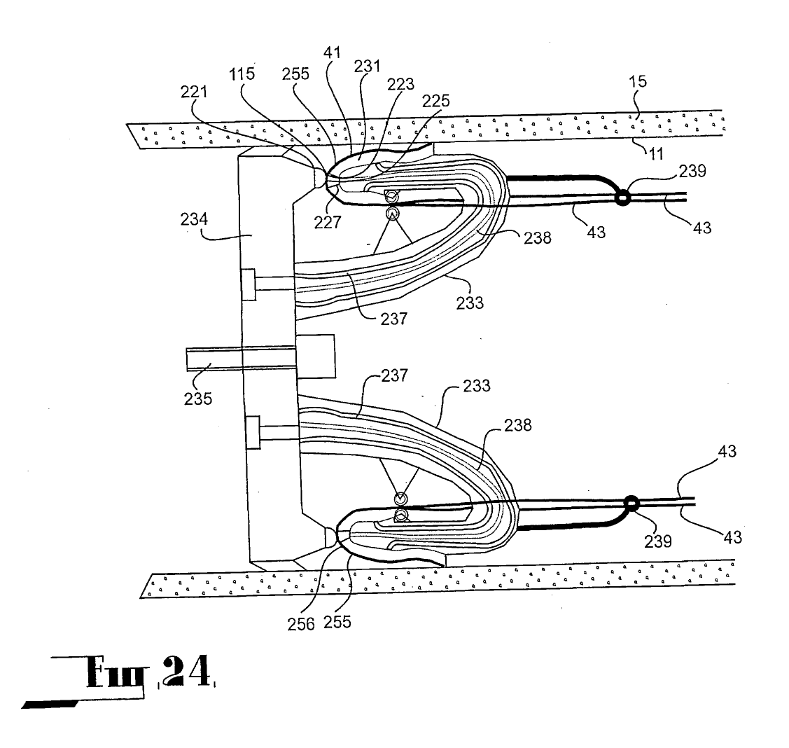

A connector member 207 is then installed between the lateral 201 and the pipeline 15, as illustrated in FIG. 21. Installation of the connector member 207 is performed by the remotely operated vehicle. The connector member 207 is in the form of a top hat, comprising a rim section 209 adapted to bear against and be adhesively bonded to the inner surface 211 of the lined pipeline, and an annular section 213 projecting from the rim section 209 to be received in the lateral 201 through the hole 205. The annular section 213 locates against, and is adhesively bonded to, the inner surface 215 of the lateral 201. In installing the connector member 207 in position, the rim section 209 is deformed to follow the contour of the inner surface 211 of the lined pipeline 15. The deformation may be achieved by the action of the connector member 207 being punched into position in the hole 205 by the remotely operated vehicle. The deformation of the rim section 209 causes radial expansion of the annular section 213, thereby urging the annular section firmly into engagement with the inner surface 215 of the lateral.

With this arrangement, the connector member 207 provided a fluid-tight connection between the pipeline 15 and the lateral 210.

Referring now to FIG. 22 of the drawings, there is shown part of the installation head 25 of apparatus 10 according to a further embodiment. The installation head 25 of this embodiment is similar to the installation head of the first embodiment, as illustrated in FIG. 5 of the drawings, except for the sealing arrangement associated with the delivery slot 115 through which the assembled liner 11 is delivered to the mandrel 113. In this embodiment, the delivery slot 115 is defined between a rigid seal 221 and a flexible seal 223. The rigid seal 221 presents a polished seal surface over which the assembled liner 11 can slide. The flexible seal is defined by a flexible wall 225 of a chamber 227. The chamber 227 is adapted to receive an inflation fluid which pressurizes the flexible wall 225 thereby urging it into engagement with the assembled liner 11 passing through the delivery slot 115. In this way, the assembled liner 11 passing through the delivery slot 15 is sealing engaged between the rigid seal 221 and the flexible seal 223.

The flexible seal 223 may be of perforated construction so that inflation fluid contained within the chamber 227 can bleed through the flexible wall 225 and thereby lubricate the seal face. This serves to reduce frictional resistance to movement of the assembled liner 11 over the flexible seal 223.

The sealing action of the seals 221, 223 is further assisted by the movement of the assembled liner 11 through the delivery slot 115, the direction of movement tending to carry any adhesive in zone 125 away from the delivery slot 115.

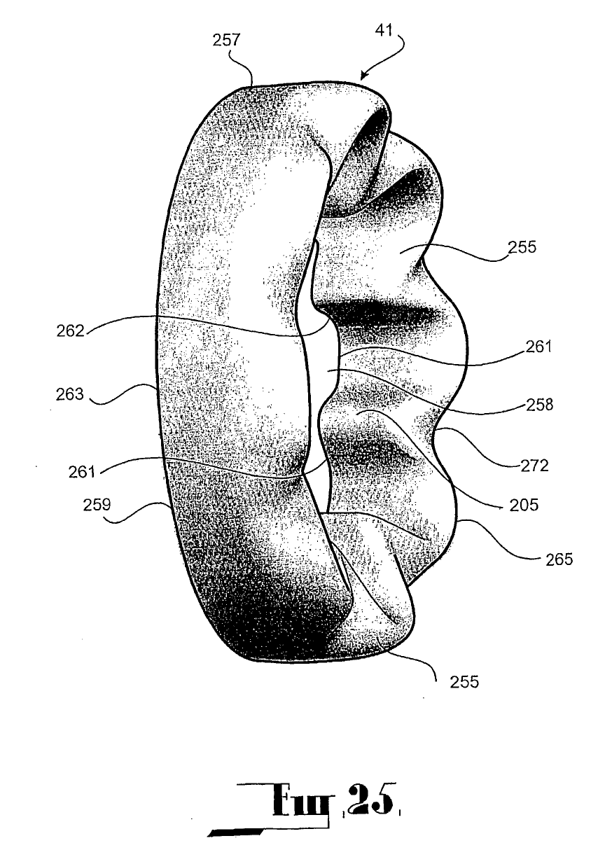

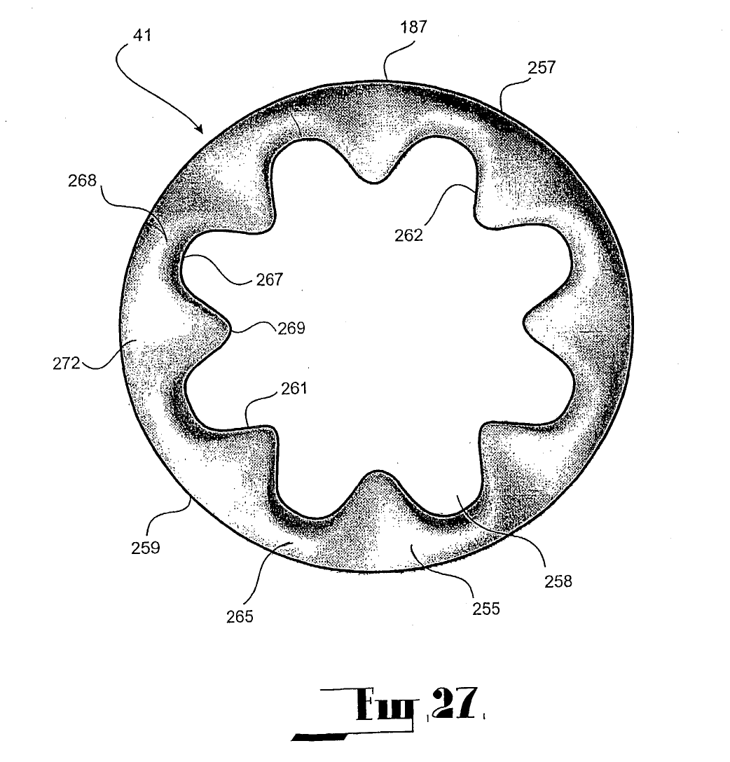

In the embodiments described previously, the various longitudinal sections 27 of flexible material turn around a guide structure in the form of guide rollers 44 mounted on the body to provide an inner portion 43 and an outer portion 45. The embodiment shown in FIGS. 23 to 29 of the drawings is directed to an apparatus which does not use a guide structure in the form of rollers.

Referring now to FIGS. 23 to 29, the guide structure 41 presents a guide surface 255 over which the longitudinal sections 27 can pass to provide the inner liner section 43 and the outer liner section 45.

The guide surface 255 presented by the guide structure 41 is of a profile which facilitates spreading of the flexible material in a manner which precludes formation of wrinkles in the outer liner portion 45.

The guide structure 41 in this embodiment comprises a guide ring structure 256 as best seen in FIGS. 25 to 28 of the drawings.

The guide ring structure 256 comprises a ring body 257 having a central opening 258. The ring body 257 presents the guide surface 255 about which the longitudinal sections 27 are adapted to turn, with the inner liner portion 43 entering the ring body 257 through the central opening 258 and then turning around the guide surface 255 such that the outer liner portion 45 leaves from the outer periphery of the ring body 257.

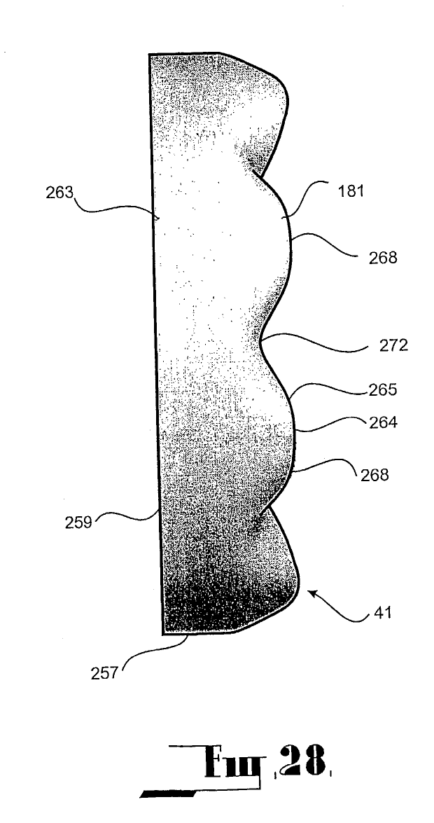

The ring body 257 has an outer circumference 259 and an inner circumference 261. The outer circumference 259 is generally circular. The inner circumference 261 is configured to provide a first substantially sinusoidal formation 262, as best seen in FIG. 27 of the drawings.

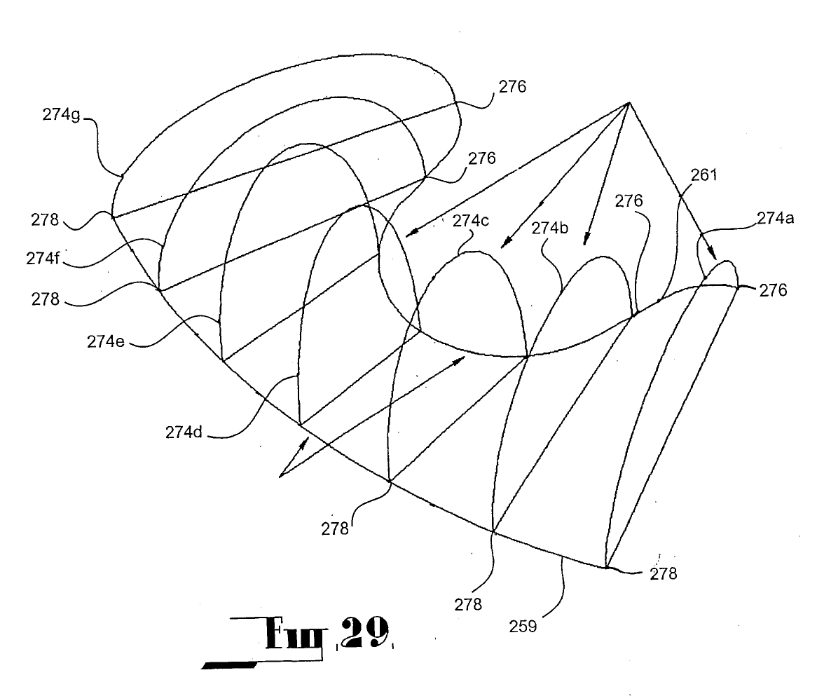

The ring body 257 has a first axial end 263 and a second axial end 264. The first axial end 263 is at the outer circumference 259 of the ring body 257 and so is generally circular. The second axial end 264 is configured to provide a second generally sinusoidal formation 265 when viewed in side elevation, as best seen in FIG. 28.

The first sinusoidal formation 262 and the second sinusoidal formation 265 are out of phase such that each trough 267 of the first sinusoidal formation 262 registers with a respective crest 268 of the second sinusoidal formation 265 in a radial direction of the ring body 257, and each crest 269 of the first sinusoidal formation 262 registers with a respective trough 272 of the second sinusoidal formation 265 in the radial direction of the ring body. This can be best seen in FIGS. 25, 26 and 27 of the drawings.

With this arrangement, the length of the inner circumference 261 equals the length of the outer circumference 259.

A further characteristic of the configuration of the guide surface 255 will now be described with reference to FIG. 29 of the drawings. The configuration of the guide surface 255 provides that any arc 274 extending across the guide surface 255 from a point 276 on the inner circumference 261 to a radially aligned point 278 on the outer circumference 259 is of constant length. In other words, the arcs 274a, 274b, 274c, 274d, 274e, 274f and 274g shown in FIG. 29 are each of the same length.

With this configuration of the guide surface 255, the lateral extent to which each longitudinal section 27 is in contact with the guide surface 255 as it turns to provide the inner liner portion 43 and the outer liner portion 45 is substantially constant. Because of the substantially constant lateral extent of contact, there is no significant tendency for irregularities such as creases, wrinkles and folds to form in the outer liner portion 45, and thus in the assembled liner 11.

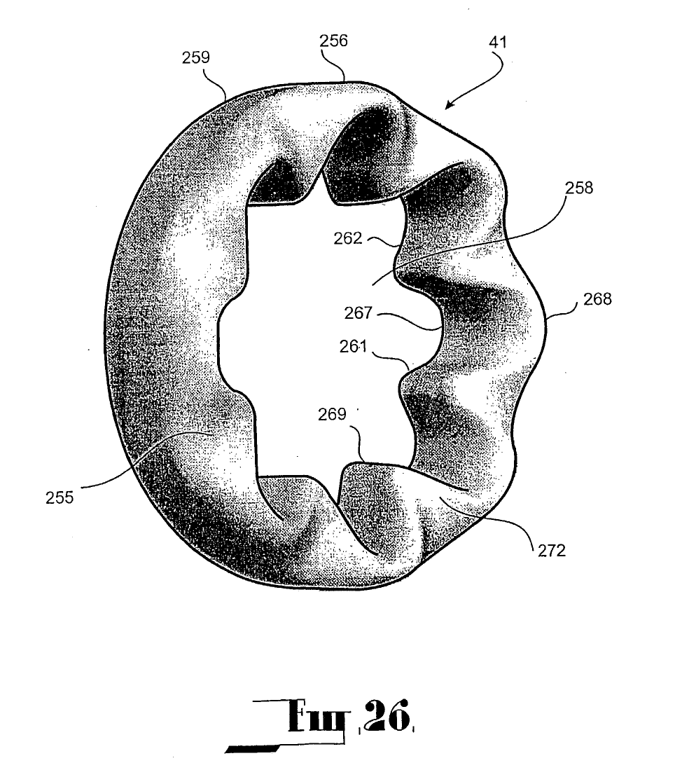

The ring structure 256 is supported on radial retaining arms 233, the inner ends of which are mounted on a support ring 234. The support ring 234 is secured to the body 23 by way of retaining bolt 235. The retaining arms 233 are connected to the ring structure 231 on the side thereof opposite to the guide surface 236; that is, on the side of the ring structure facing the direction from which the inner portion 43 approaches the ring structure, as shown in FIG. 24. The ring structure 231 and the radial retaining arms 233 are formed of a composite material incorporating carbon fibre.

In this embodiment, there are four retaining arms 233 in equally spaced circumferential relationship such that the central opening 232 within the ring structure 231 is divided into quadrants. Where the liner 11 is assembled from four longitudinal sections 27, each of those four longitudinal sections passes through one of the quadrants. The retaining arms 233 are of a width corresponding to the size of the connectors 29.

In this embodiment, the delivery slot 115 is defined between a rigid seal 221 carried on the support ring 234 and a flexible seal 223 incorporated in the guide surface 236 of the ring structure 231. The rigid seal 221 presents a polished seal surface over which the assembled liner 11 can slide. The flexible seal 223 is defined by a flexible wall 225 of an annular chamber 227 incorporated in the ring structure 231. The chamber 227 is adapted to receive an inflation fluid which pressurizes the flexible wall 225 thereby urging it into engagement with the assembled liner 11 passing through the delivery slot 115. In this way, the assembled liner 11 passing through the delivery slot 15 is sealing engaged between the rigid seal 221 and the flexible seal 223. Delivery lines 238 for delivery of inflation fluid to the chamber 227 are incorporated in the retaining arms 233.

The guide surface 255 is of perforated construction so that a lubricating fluid contained within the chamber 227 can bleed through the guide surface and thereby lubricate the surface. This serves to reduce frictional resistance to movement of the assembled liner 11 over the guide surface 255. The lubricating fluid may be of any suitable form, such as a mixture of soap and water. Delivery lines 237 are incorporated in the retaining arms 233 for delivery of lubricating fluid to the guide surface 255.

Spreaders 239 are provided for aligning the male and female elements of the connector means 29 in their approach to the pinch rollers 48, as shown in FIG. 24.

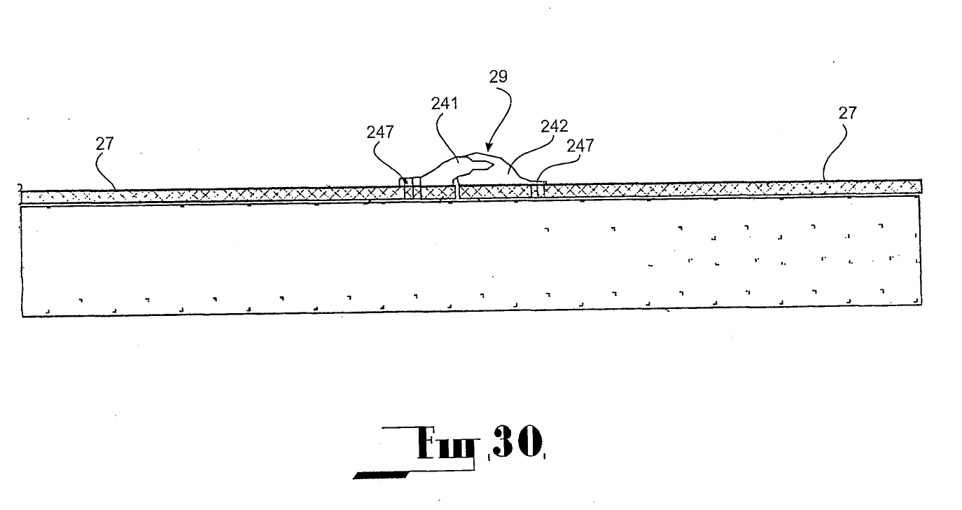

Referring now to FIG. 30, there is shown a further form of connector means 29 for joining longitudinal edges of the longitudinal sections 27 of flexible material together in a somewhat abutting relationship to form the assembled liner 11. In this embodiment, each connector means 29 comprises a first connector element 241 in the form of a male connector and a second connector element 242 in the form of a female connector. The arrangement is, however, a little different from the arrangement with earlier embodiments in that the male and female connectors 241, 242 are located to one side of each longitudinal section 27 of flexible material, that side being the side which provides the inner surface of the lined passageway. In this way, the male and female connector elements 241, 242 do not contact the surface of the passageway to which the longitudinal sections 27 are applied and adhesively bonded. This ensures that there is good contact between the longitudinal sections 27 and the surface to which they are applied.

In this embodiment, each connector element 241, 242 is secured to the respective longitudinal section 27 of flexible material in any suitable way such as by stitching 247.

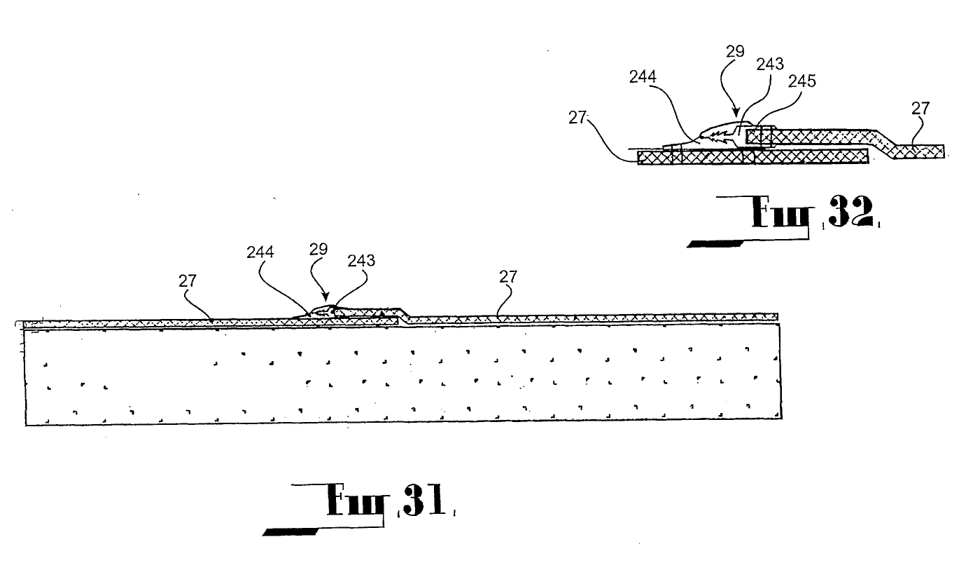

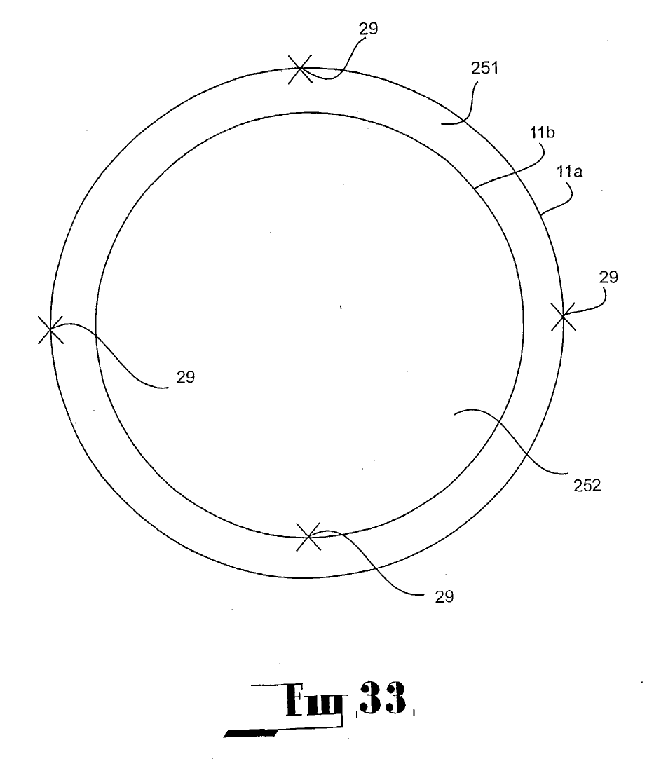

Referring now to FIGS. 31 and 32, there is shown a still further form of connector means 29 for joining the longitudinal edges of longitudinal sections 27 of flexible material together in overlapping relationship. In this embodiment, each connector means 29 comprises a first connector element 243 in the form of a male connector and a second connector element 244 in the form of a female connector. The arrangement is similar to the connector means 29 shown in FIG. 25 in that the male and female connectors 243, 244 are located to one side of each longitudinal section 27 of flexible material, that side being the side which provides the inner surface of the lined passageway. In this way, the male and female connector elements 243, 244 do not contact the surface of the passageway to which the longitudinal sections 27 are applied and adhesively bonded. This ensures that there is good contact between the longitudinal sections 27 and the surface to which they are applied.

The male element 243 is fitted onto the longitudinal edge of its respective longitudinal section 27 and the female element 244 is fitted onto its respective longitudinal section 27 inwardly spaced from the longitudinal edge thereof to provide for the overlap.

Each connector element 243, 244 is secured to the respective longitudinal section 27 of flexible material in any suitable way such as by stitching.

The male element 243 incorporates a receiving cavity 245 which extends along the length of the male element and into which the longitudinal edge of the respective longitudinal section 27 is received and secured (such as by stitches). This arrangement enhances the strength of the connection between the male element 243 and its respective longitudinal section 27 of flexible material.

It is possible to construct a pipeline or other conduit using two of the assembled liners 11 positioned one around the other with a space therebetween to receive a settable composition such as cement, concrete or a resin. One such arrangement is shown in FIG. 33 of the drawings where the outer assembled liner is identified by reference numeral 11a and the inner assembled liner is identified by reference numeral 11b. As previously mentioned, there is a gap 251 defined between the two liners 11a, 11b into which the settable composition can be introduced. By inflating the interior region 252 defined by the inner liner 11b, form and shape is provided to the assembly and in particular the pipeline being formed in the gap 251.

It will be noted that the two liners 11a, 11b are oriented such that the connector means 29 on one liner are offset with respect to the connector means 29 of the other liner.

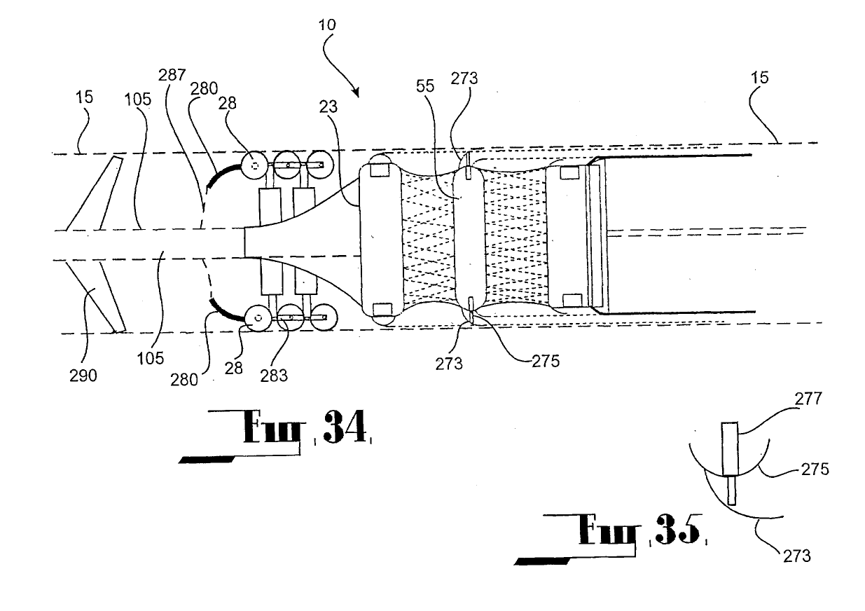

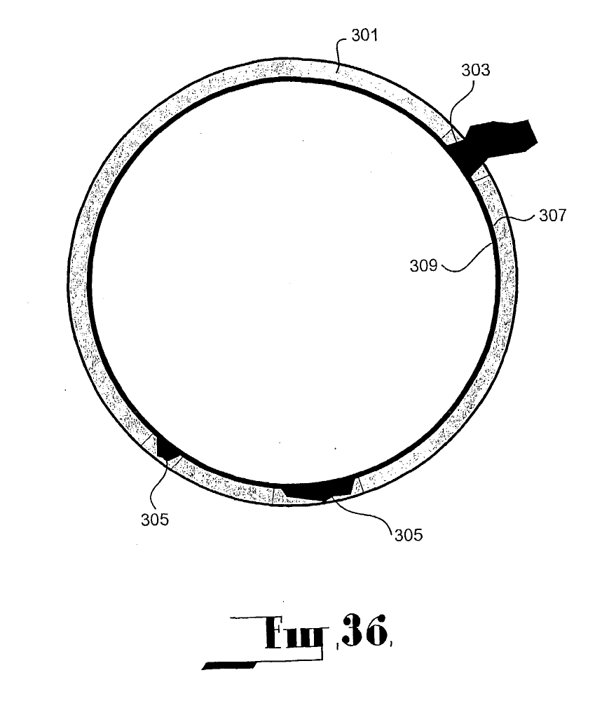

Referring now to FIGS. 34 and 35 of the drawings, there is shown a further embodiment of the apparatus 10 for installing a liner 11 into the interior surface 13 of the pipeline 15. This embodiment is similar to the first embodiment shown in FIGS. 1 to 9 of the accompanying drawings, with the exception of additional features as described below.

The apparatus 10 incorporates a control mechanism 270 for controlling the lateral position of the intermediate spreader member 55 within the pipeline 15. In other words, the intermediate spreader 55 can be positioned in an offset relationship with respect to the central longitudinal axis of the pipeline 15. When the intermediate spreader member 55 is centrally located within the pipeline, the intermediate lining so formed is of uniform circumferential thickness. There may, however, be occasions where it is desirable for the intermediate liner 19 to not have a uniform wall thickness in the circumferential direction but rather to be thicker at some locations in comparison to other locations. A particular example of such an arrangement would be where it is desirable to have a thicker wall surface along the bottom of the pipeline. This can be achieved with the embodiment shown in FIGS. 34 and 35.

The control mechanism 270 comprises a plurality of circumferentially spaced skid members 273 pivotally mounted on the intermediate spreader 55 for engagement either with the interior surface 13 of the pipeline 15 or with the intermediate lining applied to that interior surface. The skid members 273 are arranged to skim along the surface upon which they are engaged. An adjustment mechanism 275₁₃ is provided for selectively controlling the radial position of each skid member 273 with respect to the spreader member 55. In this embodiment, the adjustment mechanism 275 comprises a ram 277 connected to between each skid member 273 and the intermediate spreader 55.

There may be circumstances where the rollers 28 carrying the body 23 may encounter a large cavity within the pipeline 15. This may present difficulties in circumstances where the cavity is so large that the rollers 28 could possibly fall in the cavity and cause the body 23 to be jammed within the pipeline 15, unable to be pulled free using the tow line 24. With a view to avoiding such an occurrence, the present embodiment is provided with a skid structure 280 located ahead of the rollers 28. The skid structure 280 has its trailing end pivotally connected to the structure 283 on which the rollers 28 are mounted. The leading end of the skid structure 280 is linked by way of a flexible cable 287 to the umbilical structure 105 incorporating tow line 24. With this arrangement, if the rollers 28 do happen to drop into a cavity in the pipeline 15, the skid structure 280 can slide upwardly along the side wall of the cavity and over the edge thereof, and thereby allowing the rollers 28 (and hence the body 23 carried thereon), to be hauled out of the cavity using the tow line 24.

The apparatus 10 according to this embodiment is also fitted with a suction head 290 at the leading end of the body. The suction head 290 is provided for extracting debris in the pipeline 30 ahead of the pipelining operation. Typically, debris can accumulate in the pipeline as a result of cleaning of the pipeline prior to the lining operation. The cleaning process may involve scouring the pipeline with a so-called “pig”, or blasting the interior surface of the pipeline with a cleaning head.

From the foregoing, it is evident that the various embodiments provide a highly effective process for lining a pipeline. If the pipeline require structural repair, as well as resealing and/or to pacify corrosion, the pipeline can be lined and repaired with cement or another substrate at the same time and in the same process. A particular advantage of the process is that it can be used to line, repair and reinforce extensive lengths of pipe in one process.

The pipelining process can install a multitude of layers on the interior surface of a pipeline, with the layers performing various functions. For example, where a pipe fractured with numerous holes is being lined, the first layer would typically be cement to fill the holes and stabilise the surroundings. A pipe lined in this way is illustrated in FIG. 36 of the drawings.

Referring to FIG. 36 of the drawings, there is shown a pipeline 301 having a fracture 303 extending therethrough and various cavities 305 formed in the interior surface of the pipeline. A layer of cement 307 or other substrate is applied to the interior surface of the pipeline 301 so as to plug the fracture 303 and fill the cavities 305. The cement which plugs the fracture 303 may enter the area surrounding the pipeline, as shown in the drawing. A liner 309 is then applied to the interior surface of the cement layer 307. This operation is similar to that described in relation to the first embodiment shown in FIGS. 1 to 9 and may be performed with the apparatus 10 described therein.

There may be circumstances where it is desirable to install additional layers within a pipeline.

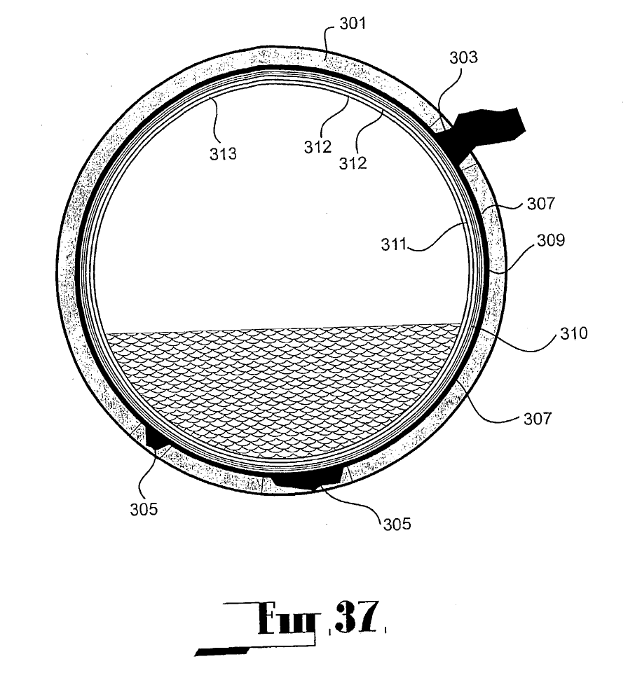

One such arrangement is illustrated in FIG. 37 of the drawings where a layer 310 of deformable, rubber modified low shear resin is sandwiched between the liner 309 and a further liner 311 applied to the pipeline 301. The inner liner 311 may be of composite construction, comprising a multitude of layers forming a rigid inner liner structure 313. Typically, the rigid liner structure would be formed of a multitude of layers 312 of fibreglass and resin. The purpose of the rigid liner structure 313 is to remain intact and break away from the pipe 301 if the integrity of the pipe is dramatically challenged, such as by rupturing or fracturing. In this way, the rigid liner structure 313 provides an interior pipe which remains intact even if the pipe 301 is breached or crushed and which contains the fluid within the pipeline.

The deformable low shear layer 310 may have self-healing characteristics. This may be achieved by in various ways, such as by forming the layer of a suitable expanding micro balloon resin, or of a mortar mix of lime and cement, or of a silica based material that on exposure to oxygen. In this way, the pipeline can be sealed to inhibit the entry of ground water.

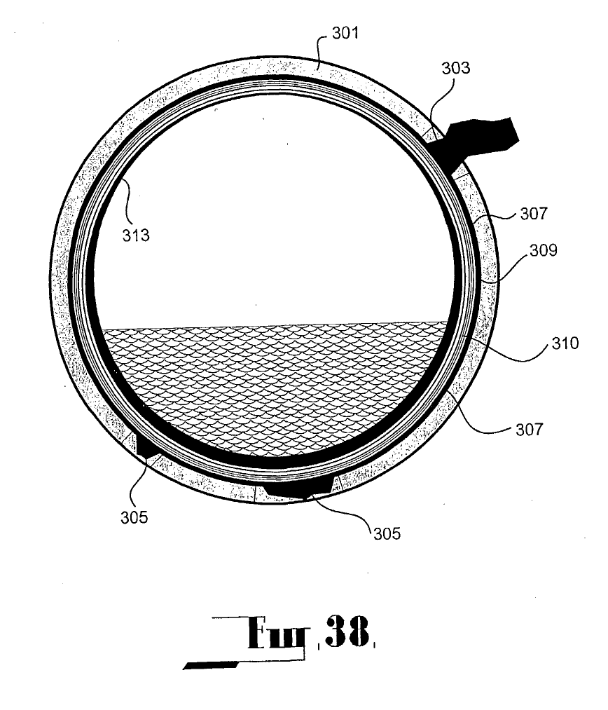

In FIG. 38 of the drawings, there is illustrated a pipeline 301 which has been lined in a similar fashion to that described in the previous embodiment with the exception that the inner liner structure 313 is of variable wall thickness in the circumferential direction. In the arrangement shown in the drawings, the liner structure 313 is thinner at the top where wear resistance would not normally be needed and thicker at the bottom where the pipeline is more likely to be exposed to the aggressive effects of fluids conveyed along the pipeline. The lining process for producing such a lining may be carried out by apparatus of the type described and illustrated in relation to FIGS. 34 and 35 of the drawings.

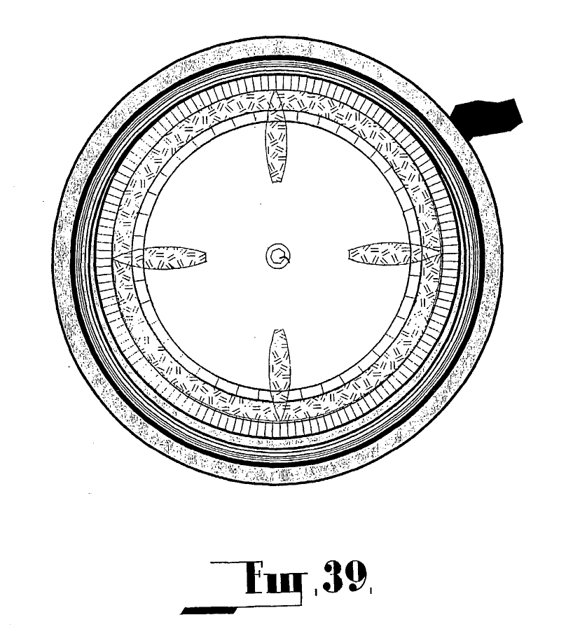

In FIG. 39 of the drawings, there is shown apparatus 10 lining a pipe 301, including installation of an inner liner 32. The apparatus 10 may be of the construction described in relation to the embodiment shown in FIGS. 23 and 24. In this embodiment, the inner liner 321 comprises a layer 323 formed from a settable composition comprising a mixture of resin and crumbed rubber. The layer 323 is retained in position during setting thereof by a liner 325 formed of flexible material such as resin-impregnated fibreglass cloth, as described in earlier embodiments.

The various layers for the pipelines illustrated in FIGS. 36 to 39 of the drawings provides a multi-layered defence system for the pipelines, which continues to allow the pipelines, which continues to allow the pipelines to remain in service (at least for a limited period of time) in the event of damage which causes failure of one of the layers.

In the embodiments described previously, the liner 11 was assembled from longitudinal sections 27 of flexible material. Other arrangements are, of course, possible. For instance, the liner 11 may be delivered to the passageway in the form of a flexible tube. The flexible tube can be turned around a guide structure to provide an inner liner portion 43 and an outer liner portion 45 as was the case with the previous embodiments, with the outer liner portion being progressively installed in position to provide the lining for the passageway.

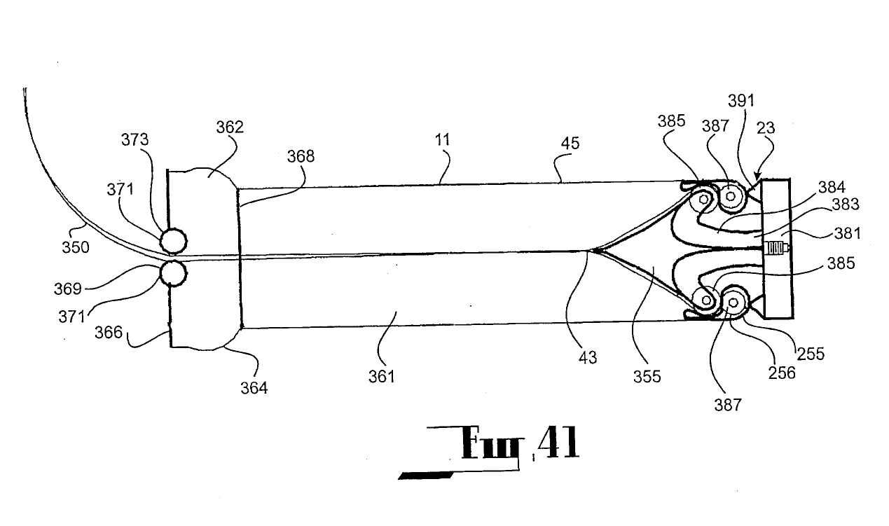

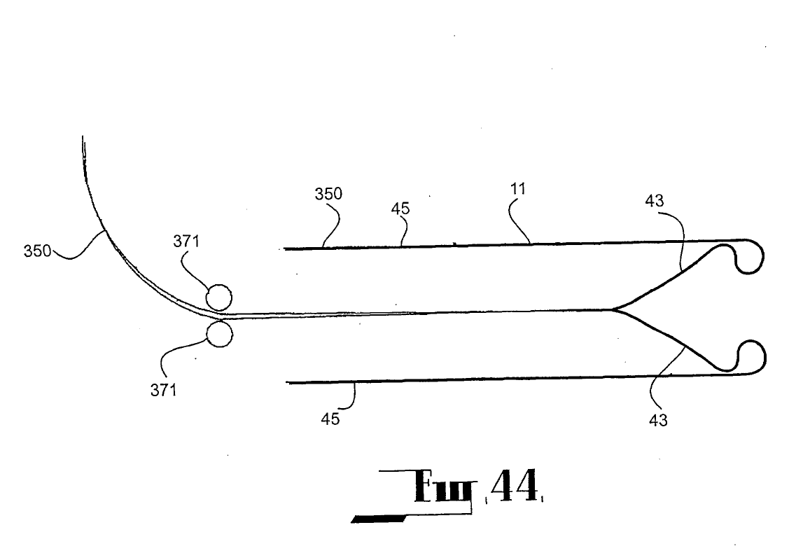

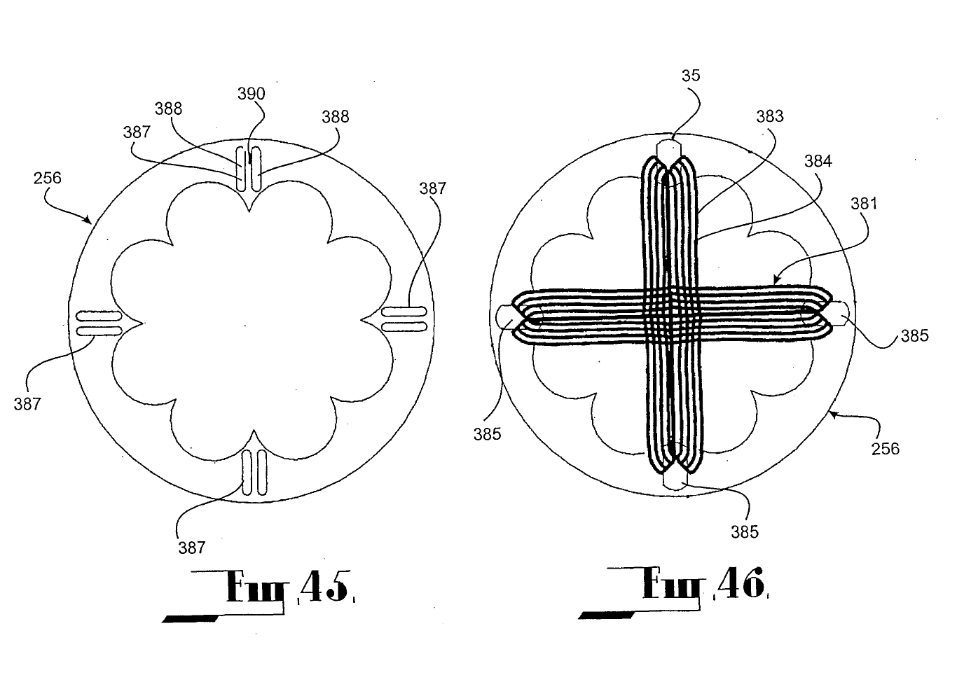

One such arrangement is utilised in the embodiment shown in FIGS. 40 to 48 of the accompanying drawings. In this embodiment, the liner 11 is in the form of tube structure 350 comprising two layers, the first layer 351 comprising a structural textile fabric such as woven fibreglass fabric and the second layer 352 comprising a flexible material impervious to air, such as for example rubberised polyethylene. The two layers are illustrated schematically in FIG. 42. The second layer 352 is oxidised on the face thereof which confronts the first layer to facilitate bonding to the first layer, as will be described later. The first and second layers 351, 352 are not, however, initially bonded together but rather the second layer 352 is merely positioned about the first layer 351. With this arrangement, the second layer 352 of rubberised polyethylene is on the outer side of the first layer 351 of fibreglass fabric. The tube structure 350 is constructed first by creating a tube of fibreglass fabric from a sheet thereof to provide the first layer 351 and then creating a tube of rubberised polyethylene about the fibreglass fabric tube to provide the second layer 352.

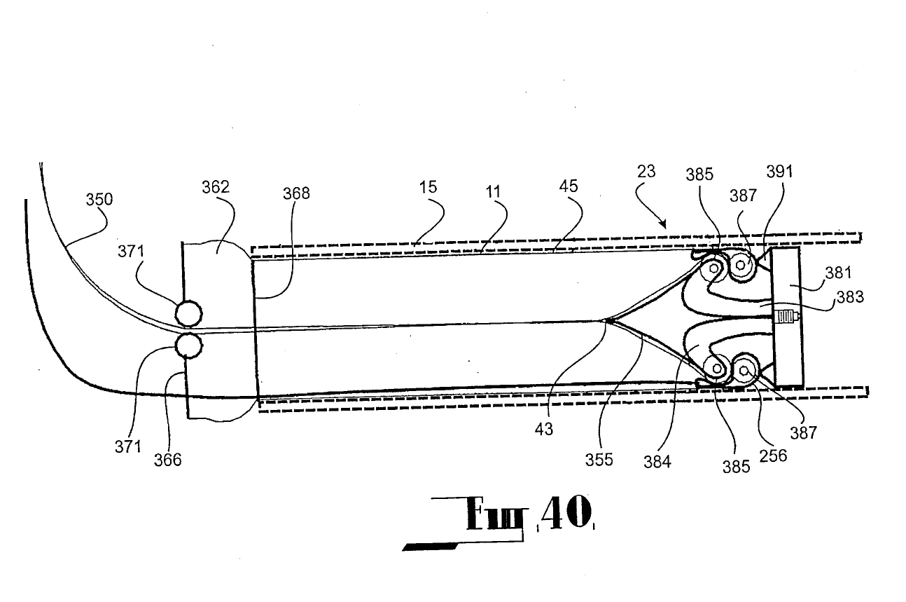

The tube structure 350 is delivered in a collapsed condition along the passageway to be lined to the body 23 at which it is turned about the guide structure 41 to provide the inner liner portion 43 and the outer liner portion 45, as best seen in FIGS. 40 and 41. In this embodiment, the guide structure 41 is in the form of a guide ring structure 256 as described in relation to an earlier embodiment and shown in FIGS. 25 to 28. In passing around the guide structure 41, the tube structure 350 is everted, with the result that the first layer 351 of woven fibreglass fabric is on the outer side of the outer liner portion 45, and the second layer 352 of rubberised polyethylene is on the inner side of the outer liner portion 45. The first layer 351 of woven fibreglass fabric is wetted with resin and presented to the interior surface of the passageway or to a substrate applied to the interior surface of the passageway. The resin used to bond the liner 11 in position also has the effect of bonding the first and second layers 351, 352 together.

The tube structure 350 is delivered to the body 25 in a longitudinally collapsed condition, the tube structure being collapsed upon itself about to diametrally opposed longitudinal fold lines. In such a collapsed condition, the tube structure 350 can be conveniently stored in roll form.

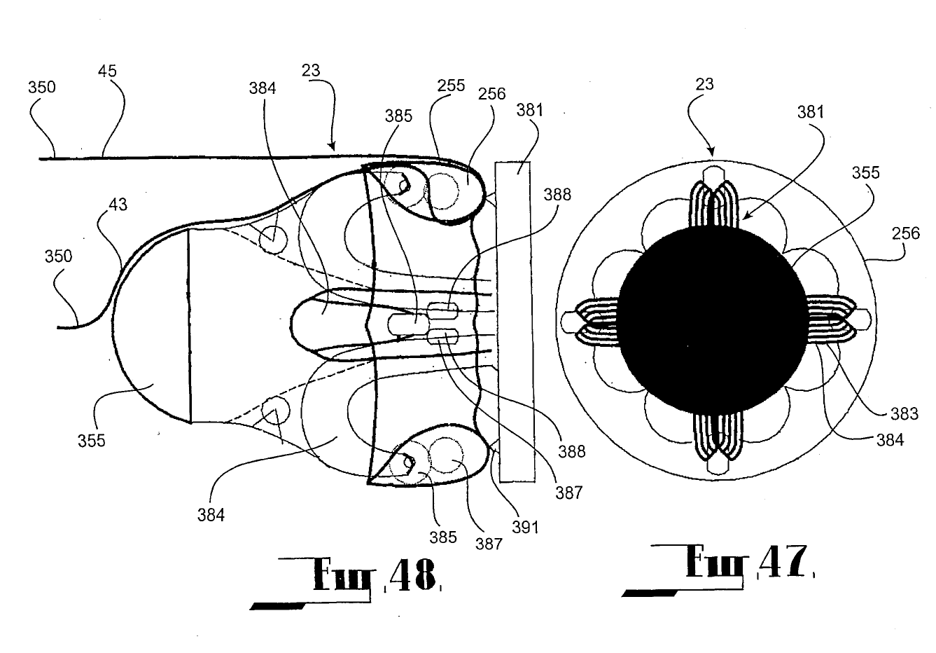

The body 23 incorporates a spreader 355 which confronts the oncoming liner inner portion 43 to facilitate spreading or fairing thereof prior to contact with the guide structure 41. The spreader 355 presents an outwardly extending surface 357 which opens the tube structure from the collapsed condition. The spreader surface 357 may be of any appropriate configuration, such as a cone or a dome. It will be noted that the spreader 355 is shown schematically as a cone in FIGS. 40 and 41, and as a dome in FIG. 48.

An inflation chamber 361 is created in the everted tube structure 350 between the inner liner portion 43 and outer liner section 45. An inflation fluid (such as air) can be introduced into the inflation chamber 361 so as to urge the outer liner portion 45 outwardly in order to maintain it in position in contact with the surface to which it is to be bonded while the bonding adhesive applied thereto sets.

The inflation fluid is introduced into the chamber 361 by way of a pressure chamber 362 installed at one end of the pipeline and via which the tube structure 350 enters the pipeline, 15 as shown in FIGS. 40 and 41. The pressure chamber 362 is defined by a housing 364 having an entry end 366 and an outlet end 368 which communicates with inflation chamber 361. The entry end 366 of the pressure chamber 362 is closed to maintain inflation pressure in the chambers 361, 362, there being provided a fluid seal mechanism 369 in the entry end 366 to allow entry of the collapsed tubular structure 350.

The fluid seal mechanism 369 comprises a pair of sealing rollers 371 positioned in side-by-side relationship to receive the collapsed tube structure 350 therebetween. Each sealing roller 371 presents a resilient sealing face 373 which contacts the collapsed tube structure 350. The effectiveness of the seal is enhanced because the second layer 352 of rubberised polyethylene is outermost at this stage and so there is effectively rubber-to-rubber contact between the collapsed tube structure and the sealing rollers 371.

FIG. 43 illustrates schematically the effect of inflation pressure within the inflation chamber 361.

As previously mentioned, in this embodiment the body 25 utilises a guide ring structure 256 of the type as described in relation to a previous embodiment and illustrated in FIGS. 25 to 28 of the drawings. In this embodiment, however, the guide ring structure 256 is not supported on radial retaining arms but rather is associated with a retaining structure 381. The retaining structure 381 comprises a frame 383 incorporating a cross-arm structure 384 which carries retaining rollers 385. The retaining rollers 385 interlock with counterpart rollers 387 provided on the guide ring structure 256. The rollers 387 are on the opposed side of the guide ring structure 256 with respect to the guide surface 255 over which the liner 11 passes. The rollers 387 comprise roller pairs 388 with a gap 390 therebetween which the respective roller 387 bridges. With this interlocking arrangement, a pulling force applied to the retaining structure 381 is transferred through the interlocking rollers 385, 387 to the guide ring structure 256. A tow line for advancing the body is attached to the retainer structure 285 for application of a pulling force thereto.

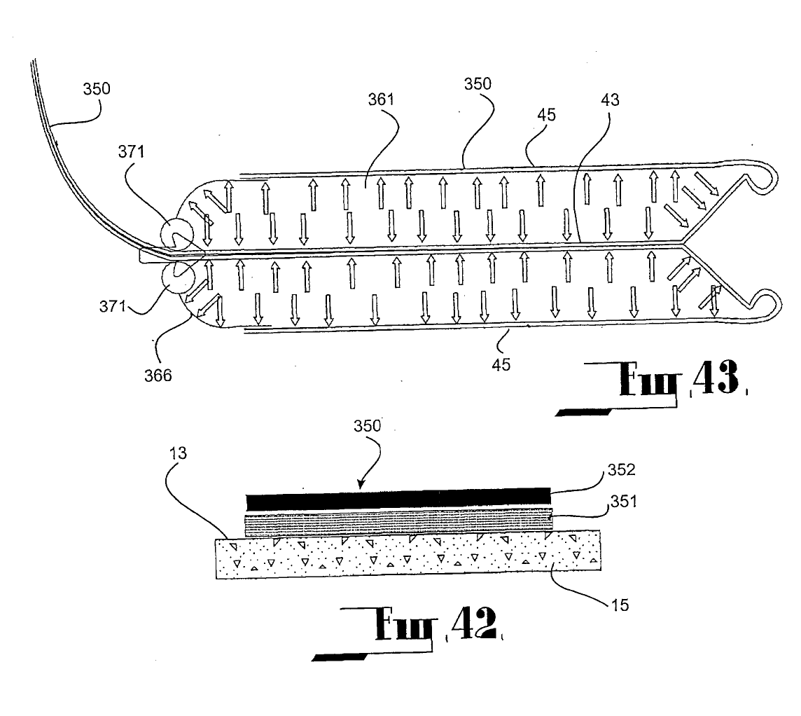

The path followed by the liner 11 between the inner liner portion 43 and outer liner portion 45 passes between the interlocking rollers 385, 387, as shown in FIGS. 40, 41 and 48 of the drawings. In other words, the liner 11 passes between the rollers 385, 387 in interlocking engagement. In this way, the connection between the retainer structure 381 and the guide ring structure 256 does not interfere with installation of the liner. The rotating action of the rollers 385, 387 about their respective rotational axes allows the liner 41 to pass between the rollers as the liner is drawn into the passageway, everted and installed in position. FIG. 44 illustrates schematically the path followed by the tube structure 350 in the installation process.

The retaining structure 381 includes a seal 391 which acts against the liner 41 as it passes over the guide surface 255 of the guide ring structure 256.

While not shown in the drawings, the body 23 in this embodiment includes an installation head having the features of the installation head 25 of the first embodiment.

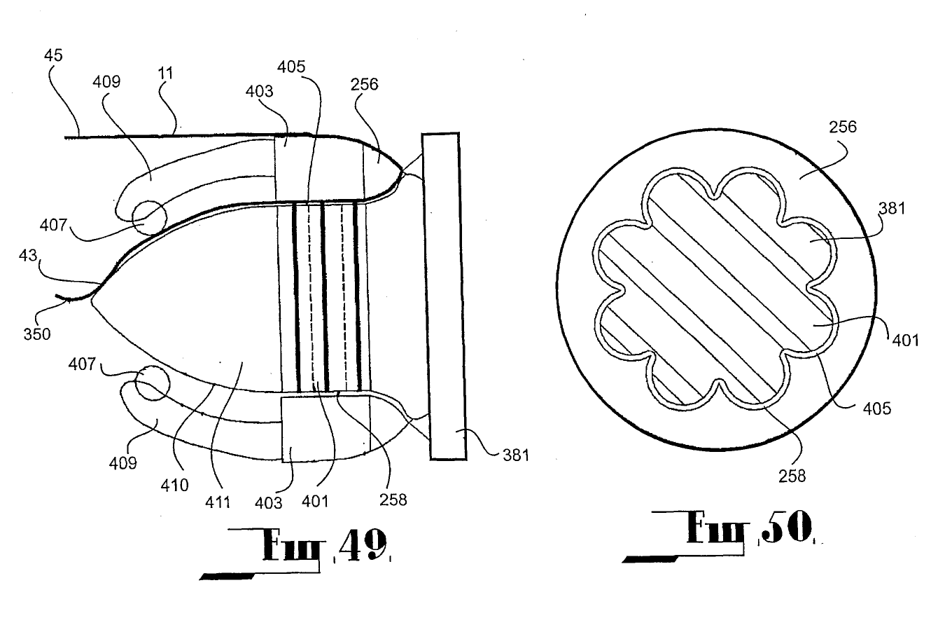

The embodiment shown in FIGS. 49 and 50 also utilises a guide ring structure 256 and a retaining structure 381, as was the case in the previous embodiment. In this embodiment, however, there is no interlocking or other mechanical connection between the guide ring structure 256 and the retaining structure 381. Rather, the connection between the guide ring structure 256 and the retaining structure 381 is a magnetic connection. Specifically, the retaining structure 381 incorporates an electromagnet 401 and the guide ring structure 256 includes a section 403 of magnetic material. The electromagnet 401 is adapted to be received in the central opening 258 of the guide ring structure 256. Magnetic interaction between the electromagnet 401 and the guide ring structure 256 transfers a pulling force applied to the retaining structure 381 to the guide ring structure 256 and hence the body 23.

A gap 405 between the guide ring structure 256 and the retaining structure 381 provides a path for the liner 11. The gap 405 is maintained by rollers 407 mounted on arms 409 carried on the retaining ring structure 256. The rollers 407 engage against the surface 410 of a spreader 411 carried on the retaining structure 381. The rotating nature of the rollers 407 permit the liner 11 to pass between the rollers 407 and the surface 410 and the spreader 411.

It should be appreciated that the scope of the invention is not limited to the scope of the various embodiments described. In particularly, it should be understood that the invention may be used to line any suitable passageway and is not limited to pipelines. For example, the invention may be used to line tunnels.

It should also be appreciated that the apparatus may be used to line passageways other than those of circular cross-section in the embodiments described. For example, the apparatus may be used to line passageways of rectangular and triangular cross-sections.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A method of lining the interior surface of a passageway comprising the steps of: providing a flexible liner for the interior surface of the passageway, and progressively installing the liner on the interior surface of the passageway or on a substrate applied to the interior surface of the passageway by bonding it thereto.

2. A method according to claim 1 wherein the liner is installed onto the interior surface of the passageway or the substrate by being adhesively bonded thereto.

3. A method according to claim 1 or 2 wherein the liner is bonded to the inner surface of the passageway or onto a substrate applied to the inner surface of the passageway using a substance which hardens and which together with the liner forms a rigid structure.

4. A method according to claim 1, 2 or 3 wherein the substance comprises an acrylic resin such as methyl methacrylate.

5. A method according to any one of claims 1 to 4 further comprising the step of aerating the resin.

6. A method according to any one of the preceding claims wherein the liner comprises a structural textile fabric such as woven fibreglass fabric.

7. A method according to claim 6 wherein the textile fabric has a smooth coating on one face thereof to present a smooth surface as the boundary wall of the lined passageway.

8. A method according to any one of claims 1 to 6 wherein the liner comprises a plurality of layers.

9. A method according to claim 8 wherein the layers are bonded one to another as part of the liner installation process.

10. A method according to any one of the preceding claims wherein the liner is assembled within the passageway from at least two longitudinal sections of flexible material having the longitudinal edges thereof adapted to be joined one to another to form the liner.

11. A method according to claim 10 further comprising delivering said at least two longitudinal sections of flexible material into the passageway and assembling said at least two longitudinal sections of flexible material to form the liner.

12. A method according to any one of claims 1 to 8 wherein the liner is delivered to the passageway in the form of a flexible tube structure.

13. A method according to claim 12 wherein the liner comprises said plurality of layers and wherein the layers are positioned one about another to form the tube structure.

14. A method according to any one of claims 2 to 13 further comprising the step of applying an adhesive substance to the interior surface of the passageway or any substrate thereon and pressing the liner into position for adhesive bonding thereto.

15. A method according to any one of the preceding claims further comprising the step of delivering an inflation fluid into the region of the passageway in which the flexible liner has been installed to press the liner into intimate contact with the internal surface or any substrate applied thereto.

16. A method according to claim 15 further comprising the step of applying a substrate to the internal surface of the passageway prior to installation of the liner.

17. A method of installing a rigid liner on the interior surface of a passageway comprising the steps of: providing a flexible liner comprising a structural textile fabric such as woven fibreglass fabric, applying an adhesive resin to the flexible liner, and progressively installing the flexible liner on the inner surface of the passageway or on a substrate applied to the interior surface of the passageway, whereby the textile fabric and the resin provide a composite material which forms the rigid liner upon curing of the resin.

18. A method according to claim 17 wherein the adhesive resin is applied onto the flexible liner.

19. A method according to claim 17 or 18 wherein the adhesive resin is applied to the surface to which the liner is to be bonded.

20. Apparatus for lining the interior surface of a passageway comprising a body adapted to be progressively moved along the passageway for installing a flexible liner onto the interior surface of the passageway or any substrate applied thereto, the body having means to progressively install the liner onto the inner face or any substrate positioned thereon as it moves through the passageway.

21. Apparatus according to claim 20 wherein the body incorporates a guide structure about which the liner can turn to provide an inner liner portion and an outer liner portion turned back with respect to the inner liner portion.

22. Apparatus according to claim 21 wherein the guide surface is configured to facilitate spreading of the outer liner portion in a manner which precludes the formation of irregularities such as wrinkles, creases and folds.

23. Apparatus according to claim 21 or 22 wherein the guide surface extends between first and second boundaries with at least one of the boundaries being arcuate, characterised in that the two boundaries are of substantially equal length.

24. Apparatus according to claim 23 wherein the equality of length of the two boundaries may be achieved by one of the boundaries being of sinusoidal profile and the guide surface having a further sinusoidal profile between the two boundaries, the two sinusoidal profiles being out of phase such that the troughs on each profile are aligned with the crests on the other profile in the direction of movement of the longitudinal sections of flexible material over the guide surface.

25. Apparatus according to claim 23 or 24 wherein the guide surface is defined by a guide ring having an outer circumference defining one of the boundaries and an inner circumference defining the other boundary.

26. Apparatus according to any one of claims 20 to 25 wherein the body has provision for delivering an adhesive substance for adhesively bonding the liner onto the internal surface of the passageway or onto any substrate applied thereto.

27. Apparatus according to any one of claims 20 to 26 wherein the flexible liner is assembled from at least two longitudinal sections of flexible material having longitudinal edges thereof adapted to be joined one to another, the body having provision for such assembly.

28. Apparatus according to claim 27 wherein in use the longitudinal sections are progressively delivered to the body along a delivery path from a station where a supply of such material is stored.

29. Apparatus according to any one of claims 20 to 26 wherein the liner comprises a tube structure.

30. Apparatus according to claim 29 wherein in use the tube structure is delivered to the body in a collapsed condition along a delivery path from a station where the tube structure is stored.

31. Apparatus according to any one of claims 20 to 30 wherein the body incorporates means for applying pressure to the liner during installation thereof on the internal surface of the passageway or any substrate thereon.

32. A method of lining the interior surface of a passageway substantially as herein described.

33. Apparatus for lining the interior surface of a passageway substantially as herein described with reference to the accompanying drawings.
